(19) United States
(12) Patent Application Publication
(10) Pub. No.: US 2018/0046779 A1
(43) Pub. Date: Feb. 15, 2018

(54) CACHING TECHNOLOGY FOR CLINICAL DATA SOURCES

(71) Applicant: PerkinElmer Informatics, Inc., Waltham, MA (US)

(72) Inventors: Chad Millen, Guelph (CA); Harold Miller-Koren, Stoney Creek (CA); Terry Lyons, Waterloo (CA); Abhinav Tiwari, Kanpur Uttar Pradesh (IN)

(21) Appl. No.: 15/233,847

(22) Filed: Aug. 10, 2016

(51) Int. Cl. G06F 19/00; G06F 17/30; G06F 21/62

(52) U.S. Cl. CPC G06F 19/363; G06F 21/6245; G06F 17/30339; G06F 17/30377

(57) ABSTRACT

Presented herein are systems and methods to automatically and periodically retrieve clinical trial data from an EDC source, process the data to transform it from its initial representation as retrieved from the EDC source into table-based format, and store the resultant transformed data in an intermediate data storage layer for access by stakeholders. Accordingly, instead of accessing source data, such as EDC ODM-XML data directly from an EDC source, a stakeholder may retrieve clinical trial data from the transformed data stored in the data storage layer. The systems and methods provide transformed data that better serves the needs of stakeholders during a clinical trial.

### FIELD OF THE INVENTION

This invention relates generally to systems and methods for processing, storing, and retrieving data recorded in clinical trials. More specifically, in certain embodiments, this invention relates to methods and systems for automatically and periodically updating and preprocessing a cache of clinical trial data from one or more data sources in order to match anticipated stakeholder needs, thereby providing greatly increased efficiency for the retrieval of up-to-date clinical trial information.

### BACKGROUND OF THE INVENTION

Clinical trials require the collection, storage, analysis, and reporting of large quantities of data. Clinical trial data includes not only the observations of disease progression and treatment effectiveness required to validate a new drug, but also data such as subject demographic information, operational data, and records of adverse side effects.

Clinical trial data is generally collected as a series of case report forms. These are designed specifically for each study, based on the particular protocol(s) to be followed during the study. The case report forms specify the type of information, such as, for example, subject identification, physical measurements, test results, question and answer responses, etc., that are to be collected. These forms are typically filled out by, e.g. medical doctors, nurses, technicians, etc., at each subject visit or interaction.

Typically, different forms are designed to record different types of information. For example, a study protocol may specify a series of regularly scheduled subject visits, and, accordingly, a particular form for entering the data recorded from each visit, for each subject. Similarly, demographic information, such as subject age, ethnicity, gender, etc., may be recorded on a specific demographics form. In another example, an adverse events form may be used to record data related to any time a subject experiences an adverse side effect over the course of a study.

Recently, electronic data capture systems (EDC systems), such as Medidata Rave, and Oracle Inform, have been developed to provide a way to collect this clinical trial information electronically, rather than via paper forms. These systems allow for up-to-date forms for a particular study to be accessed and data to be entered into them electronically. The collected clinical trial data is thereby automatically stored in a database associated with the EDC System.

Once collected, however, the raw clinical trial data still needs to be made available to a variety of stakeholders in the clinical trial sponsor organization (e.g. a pharmaceutical company), or associated with the sponsor organization. These stakeholders correspond to a variety of personnel such as medical doctors, statisticians, and managers who are responsible for monitoring, analyzing, and reporting data collected over the course of the clinical trial. For example, medical doctors responsible for clinical development may need to review clinical trial data daily or weekly to assess drug efficacy and/or safety. Additionally, a sponsor organization may employ data scientists to carry out biostatistics analysis of results. In another example, stakeholders associated with pharmacovigilance monitoring must assess and report adverse event information to drug regulatory authorities.

Thus, different stakeholders require access to different types (subsets) of up-to-date clinical trial data, and at different times. Moreover, the particular formats and client applications (e.g., software) in which they may view, process, and report data may also vary significantly. While EDC systems facilitate the collection and storage of raw clinical trial data, they do not directly address the challenge of efficiently providing stakeholders at a sponsor organization with access to clinical trial data. Currently, the process of identifying, retrieving and preprocessing clinical trial data before it can be used by a stakeholder represents a time-consuming and costly bottleneck.

There are several reasons for this. First, EDC systems typically provide clinical and operational data in a particular structure governed by their internal data model. For example, as discussed, clinical trial data typically is collected and stored as a series of forms corresponding to different subjects, and types of data collection interactions (e.g. study events such as regularly scheduled visits, demographic information recording, adverse events) as well as operational data. A typical stakeholder will be interested in a specific subset of this data. Moreover, a typical stakeholder will ultimately require data to be organized in a format other than the series of individual forms that the raw clinical trial data are typically stored as. For example, a stakeholder may require data to be organized in a traditional table format that provides a view of all the data associated with a particular type of form, e.g., all the demographic data collected from individual demographics forms for all the subjects. Accordingly, providing data to a stakeholder generally requires organizing and sorting through a large quantity of clinical trial data collected from various types of forms (and, for each type of form, individual forms for the various subjects) in order to identify a particular subset, which then must be processed to generate a particular representation.

Second, there are a variety of EDC systems and client applications that need to be coordinated so that the collected data can be used effectively by stakeholders. These are supplied by a variety of vendors, each of which may rely upon different protocols and programming languages for communication.

Third, client applications requesting data from EDC systems are dependent upon the capabilities of a particular EDC system to serve data. In particular, both the rate at which data can be accessed and the accessibility of the clinical trial data depend directly on the technology and infrastructure of the particular EDC system and source from which the data is requested. In certain cases, a particular EDC system, such as Oracle Inform, may suffer from poor performance in providing data to client applications. With regard to accessibility, in certain cases, for example, a particular EDC source may experience network outages, or heavy access loads that can limit the ability of stakeholders to access their clinical trial data.

There is therefore a need for systems and methods that can provide stakeholders with rapid on-demand access to up-to-date clinical trial data in a variety of formats that are relevant to their particular needs. These systems and methods should be extensible to varied technologies and data models that may be used by both EDC systems and client applications.

### SUMMARY OF THE INVENTION

Presented herein are systems and methods to automatically and periodically retrieve clinical trial data from an EDC source, process the data to transform it from its initial representation as retrieved from the EDC source into table-based format, and store the resultant transformed data in an intermediate data storage layer for access by stakeholders. Accordingly, instead of accessing source data, such as EDC ODM-XML data directly from an EDC source, a stakeholder may retrieve clinical trial data from the transformed data stored in the data storage layer. The systems and methods provide transformed data that better serves the needs of stakeholders during a clinical trial.

In certain embodiments, the ability to provide stakeholders with access to pre-computed table-based representations of clinical trial data offers a number of benefits over requiring them to directly retrieve and process form data from an EDC source themselves. In particular, the process of creating table-based representations of clinical trial data from data that may be provided in different formats (e.g. as snapshot data or transactional data) is non-trivial, time consuming, and dependent on the particular EDC system that correspond to the EDC source.

The systems and methods described herein effectively pre-compute many of the data processing operations that would otherwise need to be carried out by the client application software used by a particular stakeholder to compile and organize clinical trial data in a meaningful way. The systems and methods provide an ongoing, up-to-date table-based representation of clinical trial data as electronic forms associated with the study are collected. For example, in certain embodiments, the system automatically creates table-based representations of clinical trial data by first retrieving raw data from an EDC source via a data ingestion layer. The data ingestion layer passes the raw data to a parsing service that processes the data to produce an up-to-date table-based representation, referred to herein as parsed data, and then stores the parsed data in a master data storage module that is accessible by client applications.

A snapshot is a set of items/data points and their values, and the associated metadata (e.g. StudyOID, SubjectKey, StudyEventOID, FormOID, etc.) belonging to a clinical trial at a particular point in time. In certain embodiments wherein the raw data corresponds to snapshot data, the parsing service parses the raw data to extract blocks of snapshot data associated with a given snapshot. Each extracted block of snapshot data comprises (i) a form entry (e.g. a set of items/data points and their values), as well as (ii) a set of associated metadata values that can be used to identify the clinical trial, subject, study event, and form to which the extracted block of snapshot data belongs. Accordingly, each extracted block of snapshot data belongs to the same clinical trial, subject, study event, and form to which the form entry that it stores belongs.

After extracting the series of blocks of snapshot data from the raw data, the parsing service may match each extracted block of snapshot data to a particular table in a particular database of parsed data based on the clinical trial and form to which each extracted block of snapshot data belongs. The database to which a block of snapshot data is matched is the database that stores the clinical trial data to which the snapshot belongs. The particular table to which an extracted block of snapshot data is matched is the table that stores the data recorded using the form to which the extracted block of snapshot data belongs.

The parsing service may then update each table to incorporate the form entries stored in each of the extracted blocks of snapshot data that are matched to the table. For example, for a given extracted block of snapshot data matched to a particular table, the parsing service may first determine whether a corresponding row (e.g. a row that stores the form entry that the extracted block of snapshot data stores) already exists in the particular table. If a corresponding row exists, the parsing service may then update the existing corresponding row by replacing it with the data in the extracted block of snapshot data. In certain cases, if no corresponding row exists for a given block of snapshot data, the parsing service may create a new row in a data table in order to incorporate the data the block of snapshot data comprises into a data table in a database of parsed data.

In certain embodiments, raw data corresponding to transactional data can be parsed to extract a series of transactions. Similar to an extracted snapshot, each extracted transaction may comprise comprises a set of values that can be used to identify the clinical trial, subject, study event, and form to which the extracted transaction belongs. Each extracted transaction may also comprise a transaction type, and a transactionID. The transaction type is field whose value (e.g. a string) identifies whether the transaction corresponds to instructions to insert a new form entry, modify an existing form entry, or remove a form entry. Transactions that insert new form entries (e.g. insert transactions) may additionally comprise the form entry to be inserted. Transactions that update the data of an existing form entry (e.g. update transactions) may comprise only the data values to be updated. Certain transactions may remove data (e.g. a form entry) and, accordingly, comprise no data values.

After extracting the series of transactions from the raw data, the parsing service may match each transaction to a particular table in a particular database of parsed data based on the clinical trial and form to which each extracted transaction belongs. The database to which a transaction is matched is the database that stores the clinical trial data to which the transaction belongs. The particular table to which an extracted transaction is matched is the table that stores the data recorded using the form to which the extracted transaction belongs.

The parsing service may then update each table according to the instructions of the extracted transactions. For example, for a given transaction that is matched to a particular table, the parsing service may determine a corresponding row operation to be performed on the table to which the transaction is matched. For example, the parsing service may evaluate the transaction type value the transaction comprises to determine a corresponding row operation such as the insertion of a new row, the updating of an existing row, or the removal of a row.

Accordingly, data in the table may be created, and updated by successively applying the series of row operations determined from the transactions. In order to apply the row operations in the correct order, in certain embodiments, the parsing service keeps track of the order in which the transactions in the raw data are stored. The parsing service then applies the row operations determined from each transaction in the same order in which the transactions are stored. In certain embodiments, the parsing service may evaluate a transactionID value that each transaction comprises in order to determine the order in which the transactions that are matched to a particular table should be applied.

In certain embodiments wherein source data comprises snapshot data, by retrieving and parsing source data, the parsing service may first obviate the need for a client application to parse source data to extract snapshot data and incorporate them into a table of clinical trial data in the parsed data. Moreover, by storing the extracted snapshot data in a database separate from the EDC system that recorded the clinical trial data, the snapshot data may be stored using a data-model and database type that more effectively serves the needs of client applications and stakeholders. For example, the parsed data may be stored using a document database from which data can be efficiently retrieved.

In certain embodiments wherein source data comprises transactional data, the parsing service parses the source data to extract transactions, and applies the transactions to update one or more up-to-date tables of clinical trial data in the parsed data. Accordingly, the parsing service may save a client application from having to perform the time consuming process of both parsing source data to extract transactions and applying them in order to produce an up-to-date representation of clinical trial data.

Moreover, by processing raw data to produce a uniform, table-based representation of clinical trial data that is the same regardless of whether the source data was provided as snapshot data or transactional data, the systems and methods described herein allows the client applications to access and interact with clinical trial data retrieved from different EDC sources in a consistent manner.

Accordingly, in certain embodiments, by maintaining an up-to-date cache of table-based representations of clinical trial data, the systems and methods described herein pre-compute many of the data processing operations that would typically need to be carried out by the stakeholders themselves in order for them to access and utilize clinical trial data. This significantly reduces the time and effort required for a stakeholder to obtain the data they require to perform their roles in, or in association with a clinical trial sponsor organization.

In one aspect, the invention is directed to a method for managing clinical trial data from one or more studies, the method comprising the steps of: retrieving, by a processor of a computing device, source data comprising clinical trial data; (b) parsing the retrieved source data to extract data in at least one format selected from the group consisting of (i) and (ii) as follows: (i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and (ii) one or more transactions, wherein each of the one or more transactions comprises instructions for performing an incremental modification to at least a portion of the clinical trial data; and (c) storing the extracted data in a database of raw data for retrieval by a client application and/or further processing.

In certain embodiments, the retrieving of source data is carried out via a data ingestion layer for retrieving clinical trial data from an electronic data capture (EDC) source that stores clinical trial data that has been recorded by an EDC process. In certain embodiments, the method comprises retrieving, by the processor of the computing device, the source data at one or more times according to a pre-defined process. In certain embodiments, the pre-defined process comprises at least one of (i) and (ii) as follows: (i) performing one or more steps at a regular interval of time; and (ii) performing one or more steps at a pre-defined list of times. In certain embodiments, the pre-defined process comprises steps to retrieve data in response to a failure to write the extracted data to the database of raw data. In certain embodiments, the pre-defined process is defined in a job configuration file comprising a location of a source of clinical trial data and/or an identification of a portion of clinical trial data. In certain embodiments, the job configuration file comprises a location of a source of clinical trial data, wherein the location part of a uniform resource locator (URL). In certain embodiments, the job configuration file comprises an identification of a portion of clinical trial data, wherein the identification is a study name. In certain embodiments, the job configuration file comprises an identification of a portion of clinical trial data, wherein the identification of a portion of clinical trial data is a study object identifier (StudyOID) that uniquely identifies a study.

In certain embodiments, the source data is retrieved from one of one or more sources of clinical trial data, and retrieving the source data from the source of clinical trial data comprises: calling a data source plugin, wherein the data source plugin comprises a set of instructions for requesting data from the source of clinical trial data; issuing, via the data source plugin, a request for data to the source of clinical trial data; and receiving, via the data source plugin, raw data from the source of clinical trial data.

In certain embodiments, the source data is EDC Operational Data Model data (EDC ODM data) corresponding to an XML file conformant to the Clinical Interchange Standards Consortium (CDISC) specification.

In certain embodiments, the extracted data is stored in a database of raw data in a master data storage module that stores clinical trial data for one or more studies.

In certain embodiments, the extracted data comprises one or more blocks of snapshot data. In certain embodiments, the method comprises storing each extracted block of snapshot data as a document in the database of raw data for retrieval by the client application and/or further processing. In certain embodiments, at least one of the extracted blocks of snapshot data comprises operational data. In certain embodiments, the operational data comprises at least one member selected from the group consisting of an audit record, a query, a comment, and a signature. In certain embodiments, the operational data comprises an audit record. In certain embodiments, the operational data comprises an electronic signature.

In certain embodiments, the method comprises providing for display and/or processing by the client application, responsive to a request for data from the client application, at least a portion of the extracted blocks of snapshot data stored in the database of raw data.

In certain embodiments, the extracted data comprises one or more transactions. In certain embodiments, the method comprises storing each extracted transaction as a document in a database of raw data for retrieval by the client application and/or further processing. In certain embodiments, at least one of the extracted transactions comprises operational data. In certain embodiments, the operational data comprises data selected from the group consisting of an audit record, a query, a comment, and a signature. In certain embodiments, the operational data comprises an audit record. In certain embodiments, the operational data comprises an electronic signature. In certain embodiments, the method comprises providing for display and/or processing by the client application, responsive to a request for data from the client application, at least a portion of the extracted transactions stored in the database of raw data.

In certain embodiments, the method comprises updating a database of parsed data, wherein updating the database of parsed data comprises: for each extracted block of snapshot data: identifying a form to which the extracted block of snapshot data belongs; matching the extracted block of snapshot data to a table in the database of parsed data, wherein the table to which the block of snapshot data is matched contains one or more form entries belonging to the same form to which the extracted block of snapshot data belongs; and updating the table to which the block of snapshot data is matched to incorporate a form entry, wherein the extracted block of snapshot data comprises the form entry. In certain embodiments, updating the table comprises at least one of (i) inserting a new row in the table and (ii) replacing an existing row in the table, based on whether or not the extracted block of snapshot data corresponds to an existing row in the table.

In certain embodiments, the method comprises updating a database of parsed data based on the instructions for performing an incremental modification to at least a portion of the clinical trial data that each of the one or more transactions comprises. In certain embodiments, updating the database of parsed data comprises: for each extracted transaction: identifying a form to which the extracted transaction belongs; matching the extracted transaction to a table in the database of parsed data, wherein the table to which the extracted transaction is matched contains one or more form entries belonging to the same form to which the extracted transaction belongs; and applying the extracted transaction to update the table to which the transaction is matched in accordance with the instructions corresponding to the extracted transaction. In certain embodiments, applying the extracted transaction comprises: determining a transaction type of the extracted transaction and, based on the determined transaction type, performing at least one of (i), (ii), and (iii) as follows: (i) inserting a new row into the data table to incorporate a form entry stored in the extracted transaction; (ii) updating an existing row in the data table to incorporate one or more data values stored in the extracted transaction; and (iii) removing an existing row in the data table. In certain embodiments, the method comprises matching a first transaction to a first data table in the database; matching a second transaction to the first data table; determining an order in which to apply the first transaction and the second transaction; and applying the first transaction and the second transaction in the determined order.

In certain embodiments, updating the database of parsed data comprises: determining if data is being read from the database of parsed data; and if data is not being read from the database of parsed data: setting the value of a write lock field stored in the database of parsed data in order to provide an indication that data is being written to the database of parsed data; writing data to the database of parsed data; and upon completion of writing the data to the database of parsed data, setting the value of the write lock field stored in the database of parsed data in order to provide an indication that data is no longer being written to the database of parsed data. In certain embodiments, determining if data is being read from the database of parsed data comprises reading the value of a read lock field stored in the database of parsed data.

In certain embodiments, the method comprises providing, responsive to a request for data from the client application, at least a portion of one or more of the tables in the database of parsed data.

In certain embodiments, the method comprises, responsive to the retrieval of the source data, triggering updating the database of parsed data.

In certain embodiments, the database of parsed data is part of a master data storage module that stores clinical trial data for one or more studies.

In certain embodiments, the method comprises updating, by the processor, a custom data view, wherein the custom data view comprises one or more custom data tables and updating a custom data view comprises: accessing a pre-defined template that comprises one or more criteria; accessing the database of parsed data in order to retrieve one or more form entries from the database of parsed data, wherein each retrieved form entry satisfies at least one of the one or more criteria; updating one or more custom data tables to incorporate at least a portion of one or more retrieved form entries; and storing the one or more custom data tables in a database of custom data views. In certain embodiments, the database of custom data views is part of a master data storage module that stores clinical trial data for one or more studies.

In certain embodiments, each of the one or more criteria comprises at least one of (i) a clinical trial to which a form entry must belong, (ii) a subject to which a form entry must belong, (iii) a study event to which a form entry must belong, and (iv) a form to which a form entry must belong.

In certain embodiments, a first form entry incorporated into a custom data table belongs to a first clinical trial and a second form entry incorporated into a custom data table belongs to a second clinical trial, wherein the second clinical trial is a different clinical trial from the first clinical trial.

In certain embodiments, the method comprises periodically updating the custom data view to reflect updates to the clinical trial data.

In certain embodiments, the method comprises providing, responsive to a request from the client application, at least a portion of one of the custom data tables.

In certain embodiments, the method comprises storing a first copy of the parsed data in a first database and a second copy of the parsed data in a second database, wherein the second database has been updated one time fewer than the first database, such that the second database corresponds to a previous version of the parsed data.

In another aspect, the invention is directed to a system for managing clinical trial data from one or more studies, the system comprising: a processor; and a memory having instructions stored thereon, wherein the instructions, when executed by the processor, cause the processor to: (a) retrieve source data comprising clinical trial data; (b) parse the retrieved source data to extract data in at least one format selected from the group consisting of (i) and (ii) as follows: (i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and (ii) one or more transactions, wherein each of the one or more transactions comprises instructions for performing an incremental modification to at least a portion of the clinical trial data; and (c) store the extracted data in a database of raw data for retrieval by a client application and/or further processing. In certain embodiments, the instructions cause the processor to retrieve the source data via a data ingestion layer for retrieving clinical trial data from an electronic data capture (EDC) source that stores clinical trial data that has been recorded by an EDC process. In certain embodiments, the instructions, when executed, cause the processor to retrieve the source data at one or more times according to a pre-defined process. In certain embodiments, the pre-defined process comprises at least one of (i) and (ii) as follows: (i) performing one or more steps at a regular interval of time; and (ii) performing one or more steps at a pre-defined list of times. In certain embodiments, the pre-defined process comprises performing steps to retrieve data in response to a failure to write the extracted data to the database of raw data. In certain embodiments, the pre-defined process is defined in a job configuration file comprising a location of a source of clinical trial data and/or an identification of a portion of clinical trial data. In certain embodiments, the job configuration file comprises a location of a source of clinical trial data, wherein the location is part of a uniform resource locator (URL). In certain embodiments, the job configuration file comprises an identification a portion of clinical trial data, wherein the identification is a study name. In certain embodiments, the job configuration file comprises an identification of a portion of clinical trial data, wherein the identification is a study object identifier (StudyOID) that uniquely identifies a study.

In certain embodiments, the instructions, when executed, cause the processor to retrieve the source data from one of one or more sources of clinical trial data, by: calling a data source plugin, wherein the data source plugin comprises a set of instructions for requesting data from the source of clinical trial data; issuing, via the data source plugin, a request for data to the source of clinical trial data; and receiving, via the data source plugin, raw data from the source of clinical trial data;

In certain embodiments, the source data is EDC Operational Data Model data (EDC ODM data) corresponding to an XML file conformant to the Clinical Interchange Standards Consortium (CDISC) specification.

In certain embodiments, the extracted data is stored in a database of raw data in a master data storage module that stores clinical trial data for one or more studies.

In certain embodiments, the extracted data comprises one or more blocks of snapshot data. In certain embodiments, the instructions, when executed, cause the processor to store each extracted block of snapshot data as a document in the database of raw data for retrieval by the client application and/or further processing. In certain embodiments, at least one of the extracted blocks of snapshot data comprises operational data. In certain embodiments, the operational data comprises at least one member selected from the group consisting of an audit record, a query, a comment, and a signature. In certain embodiments, the operational data comprises an audit record. In certain embodiments, the operational data comprises an electronic signature.

In certain embodiments, the instructions, when executed, cause the processor to provide for display and/or processing by the client application, responsive to a request for data from the client application, at least a portion of the extracted blocks of snapshot data stored in the database of raw data.

In certain embodiments, the extracted data comprises one or more transactions. In certain embodiments, the instructions, when executed, cause the processor to store each extracted transaction as a document in a database of raw data for retrieval by the client application and/or further processing. In certain embodiments, at least one of the extracted transactions comprises operational data. In certain embodiments, the operational data comprises at least one member selected from the group consisting of an audit record, a query, a comment, and a signature. In certain embodiments, the operational data comprises an audit record. In certain embodiments, the operational data comprises an electronic signature.

In certain embodiments, the instructions, when executed, cause the processor to provide for display and/or processing by the client application, responsive to a request for data from the client application, at least a portion of the extracted transactions stored in the database of raw data.

In certain embodiments, the instructions, when executed, cause the processor to update a database of parsed data, wherein updating the database of parsed data comprises: for each extracted block of snapshot data: identifying a form to which the extracted block of snapshot data belongs; matching the extracted block of snapshot data to a table in the database of parsed data, wherein the table to which the block of snapshot data is matched contains one or more form entries belonging to the same form to which the extracted block of snapshot data belongs; and updating the table to which the block of snapshot data is matched to incorporate a form entry, wherein the extracted block of snapshot data comprises the form entry. In certain embodiments, updating the table comprises at least one of (i) inserting a new row in the table and (ii) replacing an existing row in the table, based on whether or not the extracted block of snapshot data corresponds to an existing row in the table.

In certain embodiments, the instructions, when executed, cause the processor to update a database of parsed data based on the instructions for performing an incremental modification to at least a portion of the clinical trial data that each of the one or more transactions comprises. In certain embodiments, updating the database of parsed data comprises: for each extracted transaction: identifying a form to which the extracted transaction belongs; matching the extracted transaction to a table in the database of parsed data, wherein the table to which the extracted transaction is matched contains one or more form entries belonging to the same form to which the extracted transaction belongs; and applying the extracted transaction to update the table to which the transaction is matched in accordance with the instructions corresponding to the extracted transaction. In certain embodiments, applying the extracted transaction comprises: determining a transaction type of the extracted transaction and, based on the determined transaction type, performing at least one of (i), (ii), and (iii) as follows: (i) inserting a new row into the data table to incorporate a form entry stored in the extracted transaction; (ii) updating an existing row in the data table to incorporate one or more data values stored in the extracted transaction; and (iii) removing an existing row in the data table. In certain embodiments, the instructions, when executed by the processor, cause the processor to: match a first transaction to a first data table in the database of parsed data; match a second transaction to the first data table; determine an order in which to apply the first transaction and the second transaction; and apply the first transaction and the second transaction in the determined order.

In certain embodiments, updating the database of parsed data comprises: determining if data is being read from the database of parsed data; and if data is not being read from the database of parsed data: setting the value of a write lock field stored in the database of parsed data in order to provide an indication that data is being written to the database of parsed data; writing data to the database of parsed data; and upon completion of writing the data to the database of parsed data, setting the value of the write lock field stored in the database of parsed data in order to provide an indication that data is no longer being written to the database of parsed data. In certain embodiments, determining if data is being read from the database of parsed data comprises reading the value of a read lock field stored in the database of parsed data.

In certain embodiments, the instructions, when executed, cause the processor to provide, responsive to a request for data from the client application, at least a portion of one or more of the tables in the database of parsed data.

In certain embodiments, the instructions, when executed, cause the processor to, responsive to the retrieval of the source data, trigger the updating of the database of parsed data.

In certain embodiments, the parsed data is part of a master data storage module that stores clinical trial data for one or more studies.

In certain embodiments, the instructions, when executed, cause the processor to update a custom data view, wherein the custom data view comprises one or more custom data tables and updating a custom data view comprises: accessing a pre-defined template that comprises one or more criteria; accessing the database of parsed data in order to retrieve one or more form entries from the database of parsed data, wherein each retrieved form entry satisfies at least one of the one or more criteria; updating one or more custom data tables to incorporate at least a portion of one or more retrieved form entries; and storing the one or more custom data tables in a database of custom data views. In certain embodiments, the database of custom data views is part of a master data storage module that stores clinical trial data for one or more studies. In certain embodiments, each of the one or more criteria comprises at least one of (i) a clinical trial to which a form entry must belong, (ii) a subject to which a form entry must belong, (iii) a study event to which a form entry must belong, and (iv) a form to which a form entry must belong.

In certain embodiments, a first form entry incorporated into a custom data table belongs to a first clinical trial and a second form entry incorporated into a custom data table belongs to a second clinical trial, wherein the second clinical trial is a different clinical trial from the first clinical trial.

In certain embodiments, the instructions, when executed, cause the processor to periodically update the custom data view to reflect updates to the clinical trial data.

In certain embodiments, the instructions, when executed, cause the processor to provide, responsive to a request from the client application, at least a portion of one of the custom data tables.

In certain embodiments, the instructions, when executed, cause the processor to store a first copy of the parsed data in a first database and a second copy of the parsed data in a second database, wherein the second database has been updated one time fewer than the first database, such that the second database corresponds to a previous version of the parsed data.

In another aspect, the invention is directed to a data caching system comprising: a data ingestion layer for retrieving source data from a clinical trial data source; a data management layer for: (a) parsing the retrieved source data to extract data in at least one format selected from the group consisting of (i) and (ii) as follows: (i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and (ii) one or more transactions, wherein each of the one or more transactions comprises instructions for performing an incremental modification to at least a portion of the clinical trial data; and (b) storing the extracted data in a database of raw data for retrieval by a client application and/or further processing; and a data serving layer for retrieving at least a portion of the data from the one or more databases of raw data, and providing the data to the client application. In certain embodiments, the data ingestion layer comprises a job scheduler for managing the creation, execution, and processing of data collection jobs, wherein each data collection job comprises instructions for retrieving source data at one or more times according to a pre-defined process. In certain embodiments, the pre-defined process comprises at least one of (i) and (ii) as follows: (i) performing one or more steps at a regular interval of time; and (ii) performing one or more steps at a pre-defined list of times. In certain embodiments, the pre-defined process comprises performing steps to retrieve data in response to a failure to write the extracted data to the database of raw data.

In certain embodiments, the data ingestion layer comprises: a data source plugin comprising a set of instructions for requesting data from the source of clinical trial data; and a transaction service for: issuing, via the data source plugin, a request for data to the source of clinical trial data; and receiving, via the data source plugin, raw data from the source of clinical trial data.

In certain embodiments, the source data is EDC Operational Data Model data (EDC ODM data) corresponding to an XML file conformant to the Clinical Interchange Standards Consortium (CDISC) specification.

In certain embodiments, the data management layer comprises a master data storage module for storing clinical trial data from one or more studies.

In certain embodiments, the extracted data comprises one or more blocks of snapshot data.

In certain embodiments, the extracted data comprises one or more transactions.

In certain embodiments, the data management layer comprises a database of parsed data and a parsing service for updating the database of parsed data, wherein updating the database of parsed data comprises: for each extracted block of snapshot data: identifying a form to which the extracted block of snapshot data belongs; matching the extracted block of snapshot data to a table in the database of parsed data, wherein the table to which the block of snapshot data is matched contains one or more form entries belonging to the same form to which the extracted block of snapshot data belongs; and updating the table to which the block of snapshot data is matched to incorporate a form entry, wherein the extracted block of snapshot data comprises the form entry.

In certain embodiments, the data management layer comprises a database of parsed data and a parsing service for updating the database of parsed data, wherein updating the database of parsed data comprises: for each extracted transaction: identifying a form to which the extracted transaction belongs; matching the extracted transaction to a table in the database of parsed data, wherein the table to which the extracted transaction is matched contains one or more form entries belonging to the same form to which the extracted transaction belongs; and applying the extracted transaction to update the table to which the transaction is matched in accordance with the instructions corresponding to the extracted transaction.

In certain embodiments, the data serving layer comprises: a clinical data view service for retrieving at least a portion of clinical data from the database of parsed data, and providing the data to the client application; and an operational data view service for retrieving at least a portion of operational data from the database of parsed data, and providing the data to the client application.

In certain embodiments, the data management layer comprises: a database comprising one or more custom data tables; and a custom data view update service for updating a one or more custom data tables by: accessing a pre-defined template that comprises one or more criteria; accessing the database of parsed data in order to retrieve one or more form entries from the database of parsed data, wherein each retrieved form entry satisfies at least one of the one or more criteria; updating one or more custom data tables to incorporate at least a portion of one or more retrieved form entries; and storing the one or more custom data tables in a database of custom data views.

In certain embodiments, the data management layer comprises a first copy of the parsed data stored in a first database and a second copy of the parsed data in a second database, wherein the second database has been updated one time fewer than the first database, such that the second database corresponds to a previous version of the parsed data.

In another aspect, the invention is directed to a method for managing clinical trial data from one or more studies, the method comprising the steps of: (a) retrieving, by a processor of a computing device, source data comprising clinical trial data; (b) storing the source data in a database of raw data for retrieval by a client application and/or further processing; (c) processing the raw data to update a database of parsed data, wherein updating the database of parsed data comprises: parsing the raw data to extract one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and for each extracted block of snapshot data: identifying a form to which the extracted block of snapshot data belongs; matching the extracted block of snapshot data to a table in the database of parsed data, wherein the table to which the block of snapshot data is matched contains one or more form entries belonging to the same form to which the extracted block of snapshot data belongs; and updating the table to which the block of snapshot data is matched to incorporate a form entry, wherein the extracted block of snapshot data comprises the form entry.

In another aspect, the invention is directed to a method for managing clinical trial data from one or more studies, the method comprising the steps of: (a) retrieving, by a processor of a computing device, source data comprising clinical trial data; (b) storing the source data in a database of raw data for retrieval by a client application and/or further processing; (c) processing the raw data to update a database of parsed data, wherein updating the database of parsed data comprises: parsing the raw data to extract one or more transactions, wherein each of the one or more transactions comprises instructions for performing an incremental modification to at least a portion of the clinical trial data; and updating the database of parsed data based on the instructions for performing an incremental modification to at least a portion of the clinical trial data that each of the one or more transactions comprises. In certain embodiments, updating the database of parsed data based on the instructions comprises: identifying a form to which the extracted transaction belongs; matching the extracted transaction to a table in the database of parsed data, wherein the table to which the extracted transaction is matched contains one or more form entries belonging to the same form to which the extracted transaction belongs; and applying the extracted transaction to update the table to which the transaction is matched in accordance with the instructions corresponding to the extracted transaction. In certain embodiments, applying the extracted transaction comprises: determining a transaction type of the extracted transaction and, based on the determined transaction type, performing at least one of (i), (ii), and (iii) as follows: (i) inserting a new row into the data table to incorporate a form entry stored in the extracted transaction; (ii) updating an existing row in the data table to incorporate one or more data values stored in the extracted transaction; and (iii) removing an existing row in the data table. In certain embodiments, the method comprises matching a first transaction to a first data table in the database; matching a second transaction to the first data table; determining an order in which to apply the first transaction and the second transaction; and applying the first transaction and the second transaction in the determined order.

In another aspect, the invention is directed to a system for managing clinical trial data from one or more studies, the system comprising: a processor; and a memory having instructions stored thereon, wherein the instructions, when executed by the processor, cause the processor to: (a) retrieve source data comprising clinical trial data; (b) store the source data in a database of raw data for retrieval by a client application and/or further processing; (c) process the raw data to update a database of parsed data, wherein updating the database of parsed data comprises: parsing the raw data to extract one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and for each extracted block of snapshot data: identifying a form to which the extracted block of snapshot data belongs; matching the extracted block of snapshot data to a table in the database of parsed data, wherein the table to which the block of snapshot data is matched contains one or more form entries belonging to the same form to which the extracted block of snapshot data belongs; and updating the table to which the block of snapshot data is matched to incorporate a form entry, wherein the extracted block of snapshot data comprises the form entry.

In another aspect, the invention is directed to a system for managing clinical trial data from one or more studies, the system comprising: a processor; and a memory having instructions stored thereon, wherein the instructions, when executed by the processor, cause the processor to: (a) retrieve source data comprising clinical trial data; (b) store the source data in a database of raw data for retrieval by a client application and/or further processing; (c) process the raw data to update a database of parsed data, wherein updating the database of parsed data comprises: parsing the raw data to extract one or more transactions, wherein each of the one or more transactions comprises instructions for performing an incremental modification to at least a portion of the clinical trial data; and updating the database of parsed data based on the instructions for performing an incremental modification to at least a portion of the clinical trial data that each of the one or more transactions comprises. In certain embodiments, updating the database of parsed data based on the instructions comprises: identifying a form to which the extracted transaction belongs; matching the extracted transaction to a table in the database of parsed data, wherein the table to which the extracted transaction is matched contains one or more form entries belonging to the same form to which the extracted transaction belongs; and applying the extracted transaction to update the table to which the transaction is matched in accordance with the instructions corresponding to the extracted transaction. In certain embodiments, applying the extracted transaction comprises: determining a transaction type of the extracted transaction and, based on the determined transaction type, performing at least one of (i), (ii), and (iii) as follows: (i) inserting a new row into the data table to incorporate a form entry stored in the extracted transaction; (ii) updating an existing row in the data table to incorporate one or more data values stored in the extracted transaction; and (iii) removing an existing row in the data table. In certain embodiments, the instructions, when executed by the processor, cause the processor to: match a first transaction to a first data table in the database; match a second transaction to the first data table; determine an order in which to apply the first transaction and the second transaction; and apply the first transaction and the second transaction in the determined order.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block flow diagram showing the organization of components and subsystems associated with a Data Caching architecture, according to an illustrative embodiment.

FIG. 2A is an example of a portion of an XML document containing ODM-XML data retrieved from an EDC source (e.g., Medidata Rave).

FIG. 2B. is another example of a portion of an XML document containing ODM-XML data retrieved from an EDC source (e.g., Medidata Rave) where the ODM-XML data comprises vendor specific elements.

FIG. 3A is an example of a portion of an XML document containing ODM-XML data, where the ODM-XML data comprises a snapshot.

FIG. 3B is an example of a portion of an XML document containing ODM-XML data, where the ODM-XML data comprises a transaction.

FIG. 4 is a block flow diagram illustrating a process for receiving EDC ODM-XML data and storing it as raw data according to an illustrative embodiment.

FIG. 5 is a block flow diagram illustrating a process for updating parsed data, according to an illustrative embodiment.

FIG. 6 is an example of a JSON document for storing adverse event data, according to an illustrative embodiment.

FIG. 7A is an example of a portion of an XML document containing ODM-XML data, where the ODM-XML data comprises operational data.

FIG. 7B is an example of a JSON document for storing operational data, according to an illustrative embodiment.

FIG. 8A is a schematic illustrating a workflow for retrieving ODM-XML data from an EDC data source, storing it as raw data, and creating and storing parsed data, according to an illustrative embodiment.

FIG. 8B is a schematic illustrating a workflow for updating custom data views according to an illustrative embodiment.

FIG. 9 is a schematic illustrating a workflow for serving data to a client application according to an illustrative embodiment.

FIG. 10 shows a block diagram of an exemplary cloud computing environment;

FIG. 11 is a block diagram of a computing device and a mobile computing device.

FIG. 12A is an example of a portion of an XML document containing ODM-XML data retrieved from an EDC source (e.g., Medidata Rave). The ODM-XML data represents a block of snapshot data corresponding to an single form entry.

FIG. 12B is a JSON document used to store the block of snapshot data shown in FIG. 12A.

FIG. 12C is an example of a row in a data table of parsed data corresponding to the block of snapshot data shown in FIG. 12A.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DEFINITIONS

Clinical Study, Clinical Trial: As used herein, the terms “clinical trial,” “clinical study,” and “study,” refer to research studies that test how well new medical approaches work in human subjects. Clinical trial data contains data for multiple subjects that are enrolled in the study. The number of subjects is typically governed by the duration and type of the study.

Subject: As used herein, the term “subject” refers to a human subject (e.g. a patient) participating in a clinical trial.

Study events: As used herein, the term “study event” refers to any of one or more events occurring over the course of a clinical trial that results in the collection of clinical trial data for one or more different subjects. Each study event differs from other study events in terms of the purpose of the study event, and, accordingly, the different types of data that are collected for each subject during that study event.

For example, during certain study events, demographics information such as age, gender, and race may be collected for each subject enrolled in the clinical trial. For example, certain study events may involve to perform physical examinations on subjects, or collect blood samples. Accordingly, specific types of data such as blood pressure, cholesterol levels, hemoglobin levels may be recorded for each subject during physical examinations or blood sample collection as a part of one or more study events.

Form: As used herein, the term “form” refers to a pre-defined template (e.g. a case report form as used in a clinical trial) that identifies a set of data to be recorded during a study event. A form is analogous to a page in a paper CRF book or an electronic CRF (eCRF) screen.

In certain embodiments, a form comprises a list of fields (e.g. age, weight, race, gender, blood pressure, cholesterol levels, hemoglobin levels) for which values are to be collected for each subject during a specific study event. The fields belonging to a particular form are typically logically or temporally related. For example, a demographics form may list fields such as age, gender, and ethnicity, while a physical examination form may list fields such as height, weight and systolic blood pressure. In another example, an adverse events form may identify (e.g. list) the fields for which data should be collected when a subject experiences an adverse event.

A set of data collected using a particular form comprises values for each of the fields identified by that form. For example, a set data collected using a demographic comprises values (e.g. recorded for a particular subject, during a particular study event) for each of the fields that the demographics form comprises, such as age, gender, and ethnicity.

Different forms are used to record data taken during different study events. Each study event may identify one or more forms using which data are collected during that study event.

Form entry: As used herein, the term “form entry” refers to the set of data that is recorded for a particular subject, at a particular study event, using a particular form. A form entry collected using a particular form is referred to herein as belonging to that form. Similarly, a form entry collected for a particular study event is referred to herein as belonging to that study event. Similarly, a form entry collected for a particular subject is referred to herein as belonging to that subject. Finally, a form entry collected as part of a particular study is referred to herein as belonging to that study. Accordingly, data for a clinical trial comprises a series of form entries.

Item: As used herein, the term “item” refers to an individual clinical data item, such as the age of a single subject or a single systolic blood pressure reading.

Operational data: As used herein, the term “operational data” refers to data having to do with the process of creation, deletion, recordation, and/or modification of clinical data collected during a clinical trial. Non-limiting examples of operational data include audit records, queries, and signatures. For example, an audit record may comprise information such as who performed a particular action such as the creation, deletion, or modification of clinical data, as well as where, when, and why that action was performed. In another example, operational data comprises an electronic signature applied to a collection of clinical data. The electronic signature identifies a user that accepts legal responsibility for that data. The electronic signature may comprise an identification of the person signing, the location of signing, and the date and time of signing. In certain embodiments, the electronic signature comprises a meaning of the signature as defined via the U.S. Food and Drug Administration guidelines under 21 C.F.R. Part 11. The signature meaning may be included in an XML element, such as “SignatureDef”, in accordance with the CDISC Operational Data Model Specification. In certain embodiments, in the case of a digital signature, the signature comprises an encrypted hash of the included data.

By contrast, the actual data collected during a clinical trial—such as observations by a medical practitioner of disease progression in a subject, demographic information about a subject, records of side effects, medical test results, and the like—is referred to herein as “clinical data”. The term “clinical trial data” encompasses both clinical data and operational data.

Table: As used herein, the term “table” refers to a grouping of related data. For example, a set of demographic data may be stored in a table, while a set of adverse event data may be stored in another table. A table may be represented in terms of rows and columns. Each column in the table represents a different field, such as, for example, “Date of Birth”, or “Gender”. Each row in the table represents a data set representing a single record. For example, the record of the demographic information for each subject may be stored in a different row. In another example, such as the recording of adverse events information in adverse events types of forms, multiple records may exist for a single subject. Accordingly, the adverse events information for a subject may be stored in multiple rows, each row corresponding to a record for that subject. As would be understood by one of skill in the art, the terms ‘rows’ and ‘columns’ are used to represent particular features of related data, and do not limit the manner of storage to a particular visual representation of a table, such as a spreadsheet with vertical columns and horizontal rows. For example, rows may be stored as separate documents in a file format such as JSON.

EDC source: As used herein, the term, “EDC source” refers to a memory or storage device that stores clinical trial data (clinical and operational) that has been recorded by an EDC process (e.g. using eCRFs). In certain embodiments, an EDC source comprises computational resources (e.g. processors) and instructions that, when executed by a processor, enable the EDC source to provide, responsive to a request for data by a software application, EDC data to that software application.

For example, an EDC system such as Medidata Rave, or Oracle Inform may comprise an EDC source that stores data for one or more clinical trials (alternatively, the EDC source may be external to the EDC system itself). In certain embodiments, a client application may issue a request (e.g. a HTTP GET request) to the EDC System (e.g. via a server in the EDC System) and receive, responsive to the request, a response (e.g. a HTTP response) comprising (e.g. in the response body) a document (e.g. an XML document) storing therein clinical trial data.

Source data: As used herein, the term “source data” refers to clinical trial data (clinical and operational) that has been retrieved from an EDC source. In certain embodiments, source data is operational data model-XML (ODM-XML) data retrieved from an EDC source (EDC ODM-XML data). In certain embodiments, data standards other than ODM may be used. In certain embodiments, ODM-XML data conforms to an accepted standard such as the Clinical Data Interchange Standards Consortium (CDISC).

Provide: As used herein, the term “provide”, as in “providing data”, refers to a process for passing data in between different software applications, modules, systems, and/or databases. In certain embodiments, providing data comprises the execution of instructions by a process to transfer data in between software applications, or in between different modules of the same software application. In certain embodiments a software application may provide data to another application in the form of a file. In certain embodiments an application may provide data to another application on the same processor. In certain embodiments standard protocols may be used to provide data to applications on different resources. In certain embodiments a module in a software application may provide data to another module by passing arguments to that module.

### DETAILED DESCRIPTION OF THE INVENTION

The systems and methods described herein relate to a data caching technology that mediates the transfer of data from the EDC Data Sources associated with EDC systems to the client applications used by stakeholders in or associated with clinical trial sponsors' organizations.

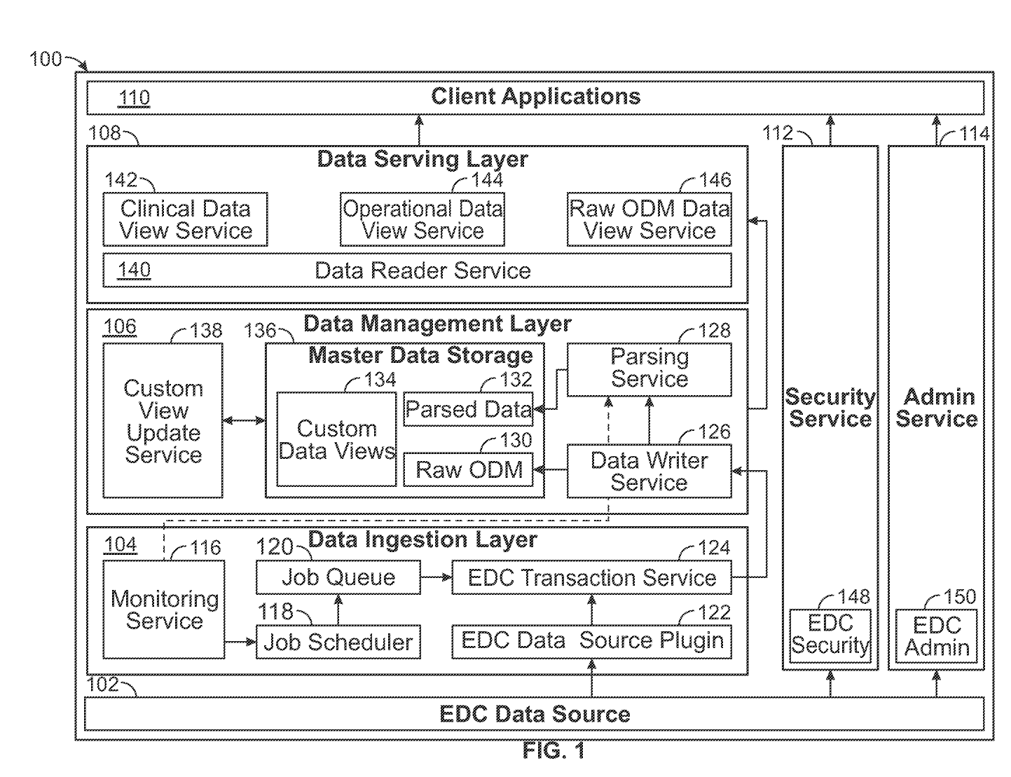

FIG. 1 is a block flow diagram showing the organization of components and subsystems associated with a Data Caching architecture, according to an illustrative embodiment. As shown in FIG. 1, the architecture comprises three layers, and two ancillary services. The three layers are a data ingestion layer 104, a data management layer 106, and a data serving layer 108. The two services are a security service 112 and an admin (administrative) service 114.

### Data Ingestion Layer

The data ingestion layer 104 retrieves source data (clinical and operational) from the EDC source 102 and passes it to the data writer service 126 of the data management layer 106. In certain embodiments, the source data is EDC Operational Data Model-XML data (EDC ODM-XML data). In certain embodiments, data standards other than ODM-XML may be used. ODM-XML data retrieved from the EDC source contains data from a clinical trial study. In certain embodiments, ODM-XML data conforms to an accepted standard such as the Clinical Data Interchange Standards Consortium (CDISC).

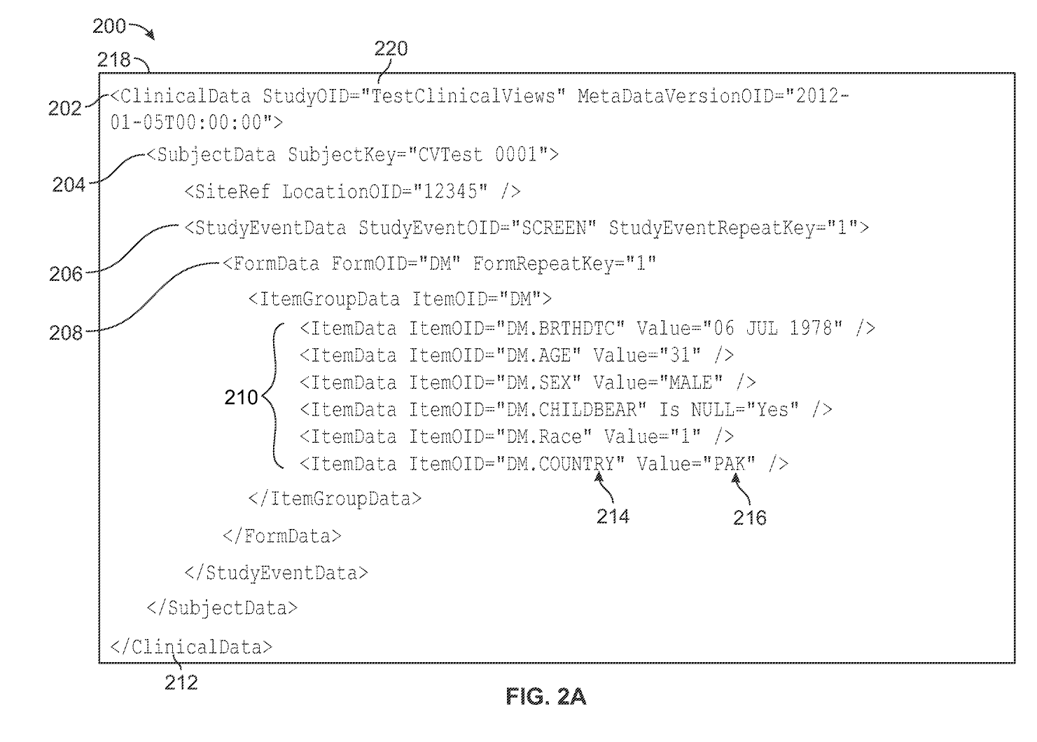

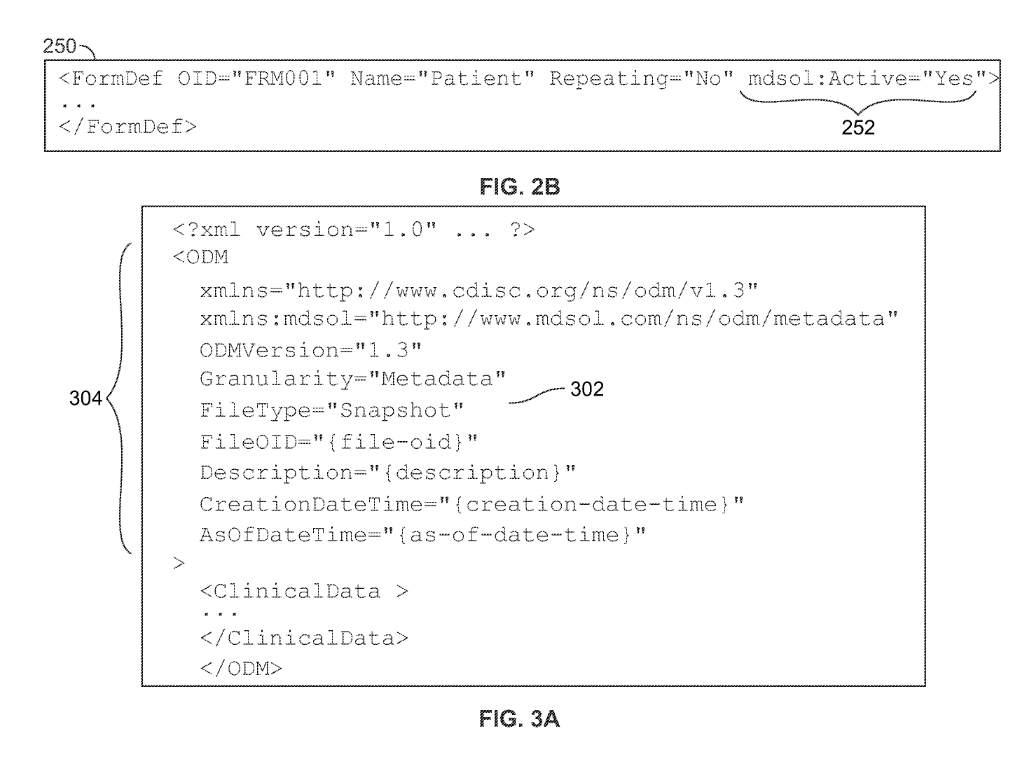

In certain embodiments, ODM-XML data is retrieved from an EDC source as one or more documents (e.g. XML documents). An example of a portion of ODM-XML data retrieved from an EDC source (e.g., Medidata Rave) is shown in FIG. 2A, where the ODM-XML data is retrieved as an XML document.

In certain embodiments, ODM-XML data is organized as an XML tree comprised of XML elements that represents the hierarchy of the clinical trial data. For example, in the portion of ODM-XML data in FIG. 2A comprises a ClinicalData element that can be identified by the start tag 202 and end tag 212. The ClinicalData element comprises children elements such as SubjectData, StudyEventData, and FormData elements whose start tags are identified as 204, 206, 208 in FIG. 2A.

The ClinicalData element identifies a particular clinical trial via the StudyOID attribute it comprises 220. All the elements and data within the ClinicalData element (e.g. in between its start and end tags) belong to that particular clinical trial. Similarly, the SubjectData element identifies a particular subject via the SubjectKey attribute that it comprises. All the children elements of a particular SubjectData element store clinical trial data for that subject. Similarly, the StudyEventData element comprises an attribute (StudyEventOID) to identify a particular study event and the FormData element comprises an attribute to identify a particular form.

The example in FIG. 2A comprises a form entry belonging to a demographics form (e.g., the FormOID attribute “DM” is a label for a demographics form). The six ItemData elements 210 store the fields of the demographics form and corresponding values that were recorded for each of those fields for the particular form entry. For example, the last ItemData element comprises an attribute whose value stores the name of a field 214 and its corresponding value 216 for the particular form entry.

An XML document comprising a complete set of clinical trial data might contain a ClinicalData element with multiple SubjectData children elements—one for each subject enrolled in the study. Similarly, each SubjectData element may comprise multiple StudyEventData elements for each study event at which clinical trial data was collected for that subject, and each StudyEventData element might comprise one or more FormData elements.

In certain embodiments, ODM-XML data retrieved from the EDC source may also include additional attributes specific to the particular EDC system, where the attributes are not defined in the CDISC standard. For example, an EDC source storing data from an EDC system such as Medidata Rave may include additional elements 252 such as those shown in FIG. 2B.

In certain embodiments, a single ODM-XML document retrieved from an EDC source may comprise all the clinical trial data for a single study. In certain embodiments, multiple ODM-XML documents may be retrieved from an EDC source, each document comprising a portion of the clinical trial data for a single study.

ODM-XML data may be retrieved from the EDC source as snapshot data, or transactional data. Snapshot data and transactional data are two ways of representing the state of the clinical trial data for a given study at a particular point in time. ODM-XLM documents that store snapshot data, and ODM-XML documents that store transactional data both may be organized in a tree structure such as the portion of the XML document shown in FIG. 2A and both may comprise elements to represent similar data.

Snapshot data stores clinical trial data as it exists at a particular point in time. Accordingly, for example, in an XML document storing snapshot data, the elements and their attributes are used to record the state of the clinical trial data at a particular point in time. In particular, a snapshot comprises set of items/data points and their values, and the associated metadata (e.g. StudyOID, SubjectKey, StudyEventOID, FormOID, etc.) belonging to a clinical trial at a particular point in time.

Transactional data instead stores clinical trial data as series of incremental modifications that can be applied to a set of clinical trial data in order to update it from a previous state to a later state. Typically these modifications correspond to real world data collection and review events that occur over the course of a clinical trial to add or change the values of clinical trial data items. Accordingly, for example, in an XML document storing transactional data, the elements and their attributes are used to record these incremental modifications. In particular, transactional data comprises a series of transactions, wherein each transaction comprises instructions for performing an incremental modification on the clinical trial data. Performing the instructions of a particular transaction in order to modify a portion of clinical trial data is referred to herein as applying the transaction.

For example, the elements in an XML document storing transactional data may comprise attributes that identify a type of modification (e.g. the insertion of new data, the updating of previously recorded data, or the removal of data). Additionally, transactional data stores the transactions in an ordered fashion, such that each transaction can be applied in the correct order in order to update a set of clinical trial data. For example, in an XML document that stores transactional data, the order that the different XML elements in the document occur (e.g. from top to bottom) may correspond to the order in which the transactions they represent should be applied. In another example, the elements in an XML document that stores transactional data may comprise a transactionID attribute whose value can be used to determine an order of the transactions (e.g. a first transaction may have a transactionID of 1, a third transaction may have a transactionID of 3).

Accordingly, snapshot data comprises a set of items/data points and their values, and the associated metadata (e.g. StudyOID, SubjectKey, StudyEventOID, FormOID, etc.) belonging to a clinical trial at a particular point in time. Transactional data comprises a series of transactions, each of which provides instructions for adding a new entry to a set of clinical trial data, or modifying an existing in a set of clinical trial data. Transactional data can be used to generate each entry in a set of clinical trial data, but also includes information (e.g. a history) on how that entry has been added to the set of clinical trial data, and changed over the course of a clinical trial.

Accordingly, in certain cases, transactional data may be preferable because it can be used to update clinical trial to a particular, current state, but also includes information describing how the data got to be in that state over time. The data caching systems and methods described herein facilitate the updating of clinical trial data from transactional data and store up to date clinical trial in a uniform format for stakeholders to access, regardless of whether the clinical trial data was updated using ODM-XML data retrieved as snapshot data or transactional data.

The data ingestion layer 104 performs and manages the retrieval and transfer of ODM-XML data by periodically executing EDC collection jobs. An EDC collection job comprises the input parameters and series of steps that are required to call the EDC Transaction Service 124 in order to retrieve EDC ODM-XML data for a particular study. In particular, an EDC collection job can include parameters such as a study URL and a study name and/or study object identifier (OID) in order to uniquely identify the study data to be retrieved from a given EDC source.

For example, a dataset to be accessed from a Medidata Rave EDC source may be accessed via a URL of the form https://my-organisation.mdsol.com/RaveWebServices/studies/{study-oid}/datasets/regular wherein the field {study-oid} is replaced with the particular study OID. For example, a study with a study OID of “MyStudy12” would be located via the URL, https://my-organisation.mdsol.com/RaveWebServices/studies/MyStudy12/datasets/regular.

An EDC collection job additionally includes a series of commands to call the EDC transaction service 124 in order to retrieve EDC ODM-XML data from the EDC source 102 and pass it to the data writer service 126 of the data management layer 106. The EDC transaction service 124 provides a level of abstraction in accordance with the principles of computer programming as would be understood by one of skill in the art. In particular, the EDC transaction service 124 interprets the calls in a particular EDC collection job in order to identify and call the particular EDC data source plugin 122. As a result, EDC collection jobs can be defined without the use of the particular conventions and instruction sets that may be specific to, and vary between different EDC systems. Thus, the specificity related to a particular EDC system is, accordingly, almost entirely limited to the EDC Data Source Plugins.

The EDC data source plugins contain the specific code to retrieve EDC ODM-XML data for a study from the EDC data Source 102. The EDC data source plugin 122 sends a request to the EDC data source 102, receives the data, and provides the retrieved EDC ODM-XML data to the EDC transaction service. Accordingly, changes to EDC system protocols, and the addition of new EDC sources can be handled simply by adding new EDC data source plugins, with minimal changes to the other components and subsystems of the Data Caching architecture.

After the EDC ODM-XML data is received by the EDC transaction service 124, the EDC transaction service 124 provides the data to the data management layer 106 via the data writer service 126.

In certain embodiments, in order to manage the retrieval of data from multiple studies, multiple EDC data collection jobs may be defined, with each job corresponding to a different study.

The frequency with which each EDC data collection job is executed may be defined in a job configuration file. In some embodiments, a job configuration file is defined for each study. The job configuration file includes parameters that uniquely identify the study and its location at a given EDC data source 102. These parameters can include a study URL, and a study OID. The job configuration file may also include parameters such as a refresh rate that defines a frequency with which a respective EDC data collection job is executed in order to update the data from the respective study. Furthermore, a job configuration file may include a parameter such as one or more specific times at which a respective EDC data collection job should be executed.

In certain embodiments, a job scheduler 118 manages the creation, execution, and processing of jobs. For example, the job scheduler 118 may comprise one or more software applications that automatically manage the execution of EDC data collection jobs running as background processes (e.g. all the processing that is associated with a particular job proceeds automatically, without any user interaction) on one or more computational resources (e.g. one or more processors). For example, the job scheduler may create EDC data collection jobs to be run periodically based on the parameters in a job configuration file. Once a job is created, the Job Scheduler may add the job to the list of jobs to be executed in the job queue 120. The jobs stored in the job queue 120 may be both persistent and non-persistent jobs. In certain embodiments, the Job Scheduler may handle the re-execution of a given job in the event that it fails to complete (e.g. due to a network failure).

In certain embodiments, the data ingestion layer also includes a monitoring service 116 that runs in the background. The monitoring service 116 may be configured to periodically check the status of write operations to the master data storage module 136 for storing raw data 130 and parsed data 132. In certain embodiments, if the monitoring service 116 determines that a write operation has failed, the monitoring service 116 communicates with the job scheduler 118 to restart the appropriate EDC data collection job.

### Data Management Layer

In certain embodiments, each time source data is retrieved from an EDC data source 102 (e.g. via the execution of an EDC data collection job), it is passed to the data management layer 106 for processing, and further storage in the master data storage module 136. The master data storage module 136 can provide storage for data such as raw data 130, parsed data 132 and custom data views 134 in one or more databases. In certain embodiments, different databases are used to store the raw data 130, parsed data 132, and custom data views 134.

As will be clear to one of skill in the art, the databases used to store data in the master data storage module 136 are not limited to a particular software implementation, or specific set of required features. A variety of software applications may be used to implement the databases used in the master data storage module 136. For example, current NoSQL document based databases such as MongoDB, or CouchDB may be used to provide capabilities such as horizontal scaling, automatic sharding, indexing, and replication, as well as fault-tolerance.

Similarly, the master data storage module 136 is not limited to a particular hardware implementation. For example, because the Master data storage module 136 is not necessarily associated with a third party EDC system (as, e.g., an EDC Data Source may be), the implementation of the Master data storage module 136 may also be optimized with respect to the needs of a particular sponsor organization and/or their stakeholders. For example, the data for a single study may be spread across multiple servers.

Particular working embodiments, and examples of data presented herein are based on a MongoDB implementation; however, one of skill in the art will understand that a variety of database technologies, not limited to document based databases (e.g. including also relational databases, column family databases, graph databases), may also be used (e.g. with the data-model changing accordingly). Different database types store data in accordance with different data-models (e.g. ways of representing data). For example, the document based database of the illustrative MongoDB based embodiment described herein stores data in the form of a document, in particular a JSON format. In certain embodiment, a relational database that stores data in a relational model can be used. In certain embodiments, a column-family database may be used. A column-family database stores data in the form of rows wherein each row comprises one or more column-families and each column-family comprises one or more columns. In certain embodiments, a graph database that stores data in a graphical structure can be used.

A different database type and corresponding data-model may be selected for storing clinical trial data depending on the particular requirements or anticipated needs for data storage and retrieval for that particular clinical trial. For example, if the retrieval efficiency of the clinical trial data for a particular study is prioritized, a data-model and corresponding database type that offers the highest data retrieval efficiency may be selected to store that clinical trial data. In another example, if the velocity of the incoming clinical trial data (e.g. the rate of incoming data) to be stored in the master data storage module is very high, but the data is not retrieved (e.g. by stakeholder client applications for analysis) frequently, then a data-model that enables data to be written efficiently may be selected. For example, a data-model and corresponding database that closely resembles the data-model of the incoming data may be selected such that minimal, or no manipulation of the incoming data is required before it is written to a database in the master data storage module.

A first type of data that can be stored in the master data storage module 136 is raw data 130. Raw data duplicates the EDC ODM-XML data in the master data storage module 136. In certain embodiments, raw data is the same as the EDC ODM-XML data. In certain embodiments, the raw data may be stored in a different file format (e.g. a JSON document as opposed to an XML document) than the original EDC ODM-XML data.

In certain embodiments, the data writer service 126 provides, and updates the raw data 130. In particular, the data management layer 106 receives EDC ODM-XML data via the data writer service 126. The data writer service 126 then (i) incrementally writes the received EDC ODM-XML data to the master data storage module 136 as raw data 130; and (ii) triggers the parsing service 128 that transforms the raw data 130 into parsed data 132.

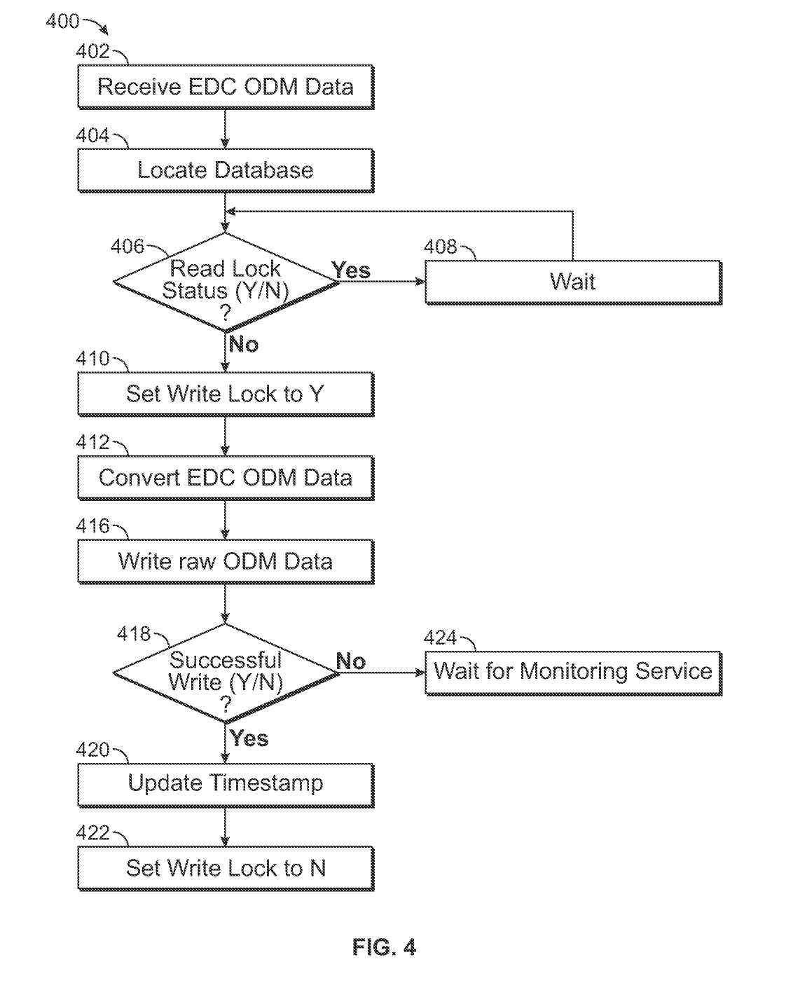

An illustrative embodiment of a process for writing the received EDC ODM-XML data to the master data storage module 136 as raw data 130 is shown in FIG. 4. The process 400 begins with the data writer service 126 receiving EDC ODM-XML data from the EDC transaction data service 124 (402). The data writer service 126 may manage and process data storage operations for one or more studies that may be stored in one or more databases. For example, data from each study may be stored in a separate database. Accordingly, after receiving EDC ODM-XML data, the process proceeds to locate the database (404) in which the raw data 130 corresponding to the received EDC ODM-XML data should be stored.

In certain embodiments, in order to maintain data integrity (e.g. manage conflicting read/write operations and keep a record of the most recent update) each database that stores raw data 130 comprises a series of fields that are checked and modified before and after each read and write operation. For example, each database may contain a “Read Lock”, “Write Lock”, and “Update Process Timestamp” field. The values stored in the “Read Lock” and “Write Lock” fields indicate whether the database is being read from or written to at a given point in time. For example a values of “Y” stored in the “Read Lock” field of a particular database may indicate that data is currently being read from the database. Alternatively, a value of “N” stored in the “Read Lock” field of a particular database may indicate that no data is currently being read from the database. Similarly values of “Y” or “N” stored in the “Write Lock” field may correspond to indications that data either is or is not being written to the database, respectively. As would be clear to one of skill in the art, the values of “Y” and “N” are illustrative and a variety of values and data types may be used to indicate the state of the database. For example, a string value of “Yes”, a numeric “1” or a Boolean “True” may be used instead of “Y”.

In certain embodiments, before attempting to write data to a particular database, the data writer service 126 may check the value of the “Read Lock” field to determine whether or not data is being read from the database (406). If the value of the “Read Lock” field is, for example, “Y”, then the process proceeds to wait until the read operation has completed before attempting to write data to the database (408). If the value of the “Read Lock” Status field is, for example, “N”, the process proceeds with the write operation, setting the value of the “Write Lock” field of the database to “Y” (410) to indicate that the database is locked for writing and prevent read operations from occurring while data is being written to the database.

After setting the “Write Lock” field to indicate that the database is locked for writing, the data writer service 126 may convert the file type of EDC ODM-XML data from the EDC data source 102 into another file type (412) (e.g an XML document may be converted to one or more JSON documents) before it is stored as raw data 130 in the master data storage module 136. This provides flexibility for the data caching technology to use a variety of database systems, independent of the particular database system that is specific to the EDC source. For example, in a particular embodiment wherein a master data storage module 136 uses MongoDB, the data writer service 126 may convert the EDC ODM-XML data into a JSON format to be stored as raw data 130 in the database.

Once the EDC ODM-XML data is converted into the desired format for storage as raw data 130 in the master data storage module 136, the data writer service 124 then writes the raw data 130 to the identified database (416), and confirms that the write operation was successful (418). If the write operation is successful, the data writer service 126 updates the value of the “Update Process Timestamp” field stored in the database with the current timestamp (e.g. date and time) (420) and sets the value of “Write Lock” field to “N” (422).

In certain embodiments, if the write fails, the value of the “Update Process Timestamp” field is not updated, and accordingly reflects the time of the previous, last successful update (424). Additionally, the value of the “Write Lock” field also remains “Y”, which prevents further writing of data to the database.

Although described herein with respect to writing data to a database storing raw data, any of the databases described herein that are used to store another type of data (e.g., parsed data or custom data views) in the master data storage module 136 may include a “Write Lock” whose value indicates whether or not the data is being written to the database, and a “Read Lock” field whose value indicates whether or not the data is being read from the database. Similarly, in certain embodiments, any time a write to any of the databases in the Master Data Storage module is not successful, the value of the “Write Lock” field of that database may be kept as “Y” to prevent further writing of data to the database.

In certain embodiments, the monitoring service 116 of the data ingestion layer 104 may be used to check for write failures, and re-start the process of retrieving EDC ODM-XML data from an EDC data source 102 and storing the corresponding raw data 130. For example, the monitoring service 116 may check the value of the “Update Process Timestamp” field of the databases storing raw data 130 in the master data storage module 136 at periodic, pre-defined time intervals. In certain embodiments, if the value of the “Update Process Timestamp” field for a database storing raw data 130 is older than a pre-determined time-limit (e.g. more than twenty-four hours old), the monitoring service determines that a write failure has occurred.

In certain embodiments wherein the raw data corresponds to transactional data, upon determining that a write failure has occurred, the monitoring service 116 retrieves the value of a transaction ID of the last (e.g. most recent) transaction that was inserted into the raw data. The monitoring service then initiates the appropriate EDC data collection job (e.g. the job that is configured to retrieve the raw data for the appropriate clinical trial study) via the job scheduler. The monitoring service additionally may pass the transaction ID of the last inserted transaction to the EDC data collection job in order to identify the most recent transaction that was successfully written to the raw data. Accordingly, the EDC data collection job may only retrieve transactional data comprising the series of transactions that were not successfully inserted into the raw data. In certain embodiments wherein the raw data corresponds to snapshot data the monitoring service will initiate the appropriate EDC data collection job via the job scheduler. Snapshot data does not comprise transactions and, accordingly, retrieval of a transaction ID is not required for snapshot data. Accordingly, the EDC data collection job may retrieve the most recent snapshot data, and the data writer service 126 may attempt to rewrite the snapshot to the raw data.

In addition to writing raw data 130 to the master data storage module 136, the data writer service 126 may also trigger the parsing service 128 to initiate the process of updating the parsed data 132 in the master data storage module 136 based on the stored raw data 130.

In certain embodiments, parsed data 132 is derived from raw data 130. Parsed data 312 may be represented as a one or more of tables. Each table of the one or more tables may be used to store all the data collected using a particular form. For example, parsed data may include a demographics table that stores all the demographic data (e.g. all the entries) collected using demographics forms for all the subjects, and all the study events. Each column in the demographics table may represent a different field, corresponding to a different piece of information to store (e.g. age, gender, ethnicity). Each row in the demographics table stores a different entry.

In certain cases, a table may comprise exactly one row for each subject in the clinical trial. For example, data may be collected using a particular form exactly once for each subject. For example, demographics information may be collected once for each subject using a demographics form at a single study event (e.g. an enrollment study event). Accordingly, there may exist one entry belonging to the demographics form for each subject. Therefore, the demographics table in the parsed data will comprise a single row for each subject.

In certain cases, certain tables corresponding to certain forms may have multiple rows corresponding to a single subject. For example, data from forms designed to record adverse events may all be stored in a single table. Each subject in a study may have zero, one, or more adverse events, resulting in zero, one or more rows of data for each subject.

In certain embodiments, similar to raw data 130, parsed data 132 for each study may be stored in a separate database.

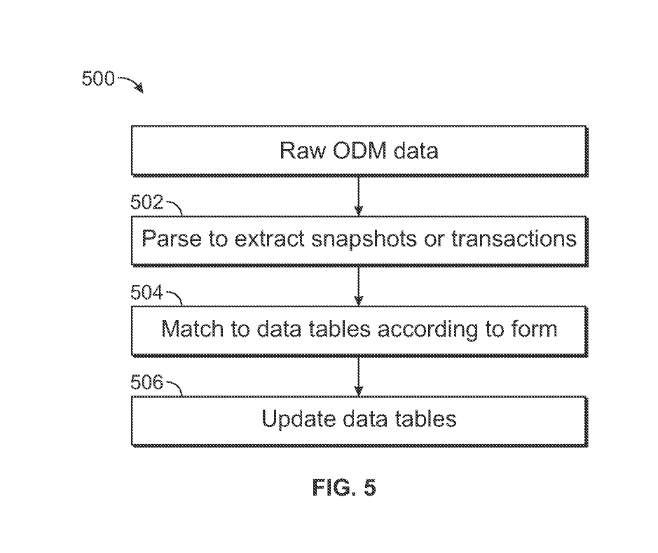

An example process for retrieving raw data 130 and updating parsed data 132 for a study is shown in FIG. 5 In the process 500, the parsing service 128 is triggered by the data writer service 126 and receives new raw data 130 from the data writer service 126. The parsing service 128 parses the raw data 130 to identify and extract snapshots or transactions based on whether the raw data is snapshot data or parsed data.

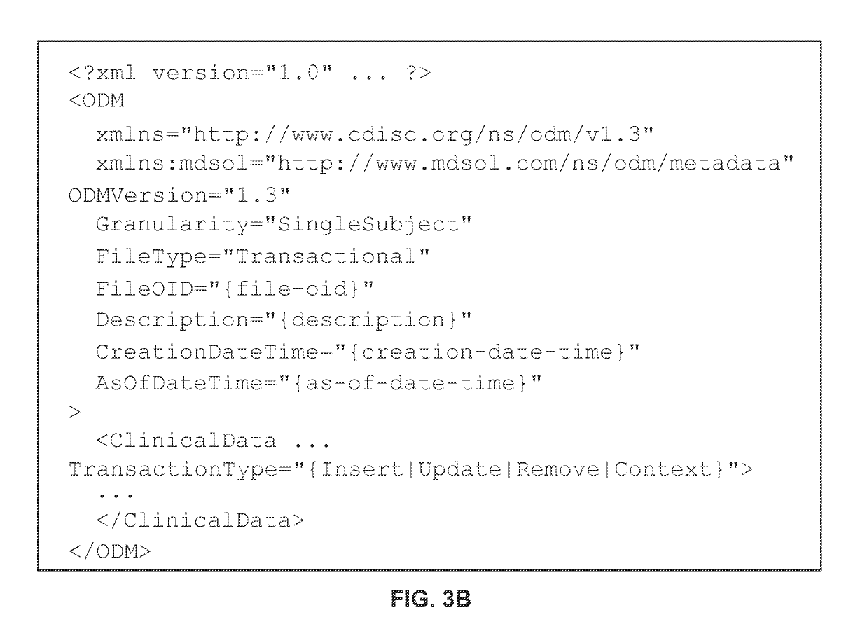

In certain embodiments, each ODM-XML document may comprise a header element at the beginning of the document that identifies whether the document comprises snapshot data or transactional data. For example, FIG. 3A shows a portion of ODM data retrieved from an EDC source as an XML document. The portion of the ODM data in FIG. 3A comprises a header element 304 that comprises a FileType attribute 302 that identifies the ODM data in the document as snapshot data (e.g. the value of the FileType attribute is “Snapshot”). Similarly, FIG. 4A shows an example of a portion of ODM data retrieved from an EDC source as an XML document. The portion of ODM data in FIG. 3B comprises a header element that comprises a FileType attribute that identifies the ODM data in the document as transactional data (e.g. the value of the FileType attribute is “Transactional”).

A snapshot can be parsed to extract blocks of snapshot data. Each extracted block of snapshot data snapshot comprises (i) a form entry, as well as (ii) a set of values that can be used to identify the clinical trial, subject, study event, and form to which the extracted block of snapshot data belongs. Accordingly, each extracted snapshot belongs to the same clinical trial, subject, study event, and form to which the form entry that it stores belongs.

For example, the portion of ODM-XML data shown in FIG. 2A is an example of a snapshot comprising a series of XML elements. A block of snapshot extracted from the ODM-XML data in FIG. 2A will comprise the data is stored in the ItemData elements 210. The set of values that identify the clinical trial, subject, study event, and form to which the extracted snapshot data belongs are the values of the StudyOID, SubjectKey, StudyEventOID and FormOID attributes.

After extracting a series of blocks of snapshot data from the raw data, the parsing service may match each extracted snapshot to a particular table in a particular database of parsed data based on the clinical trial and form to which each extracted snapshot belongs. The database to which a snapshot is matched is the database that stores the clinical trial data to which the snapshot belongs. The particular table to which an extracted snapshot is matched is the table that stores the data recorded using the form to which the extracted snapshot belongs.

The parsing service may then update each table to incorporate the entries stored in each of the extracted snapshots that are matched to the table. For example, for a given extracted block of snapshot data matched to a particular table, the parsing service may first determine whether a corresponding row (e.g. a row that stores the form entry that the extracted block of snapshot data stores) already exists in the particular table. If a corresponding row exists, the parsing service may then update the existing corresponding row by replacing it with the data in the extracted block of snapshot data. In certain cases, if no corresponding row exists for a given snapshot, the parsing service may create a new row in a data table in order to incorporate the data values the extracted block of snapshot data comprises into a data table in a database of parsed data.

In certain embodiments, transactional data can be parsed to extract a series of transactions. Similar to an extracted snapshot, each extracted transaction may comprise a set of values that can be used to identify the clinical trial, subject, study event, and form to which the extracted transaction belongs. Each extracted transaction may also comprise a transaction type, and a transactionID. The transaction type is field whose value (e.g. a string) identifies whether the transaction corresponds to instructions to insert a new entry, modify an existing entry, or remove an entry. Transactions that insert new entries (e.g. insert transactions) may additionally comprise the entry to be inserted. Transactions that update the data of an existing entry (e.g. update transactions) may comprise only the data values to be updated. Certain transactions may remove data (e.g. an entry) and, accordingly, comprise no data values.

After extracting the series of transactions from the raw data, the parsing service may match each transaction to a particular table in a particular database of parsed data based on the clinical trial and form to which each extracted transaction belongs. The database to which a transaction is matched is the database that stores the clinical trial data to which the transaction belongs. The particular table to which an extracted transaction is matched is the table that stores the data recorded using the form to which the extracted transaction belongs.

The parsing service may then update each table according to the instructions of the extracted transactions. For example, for a given transaction that is matched to a particular table, the parsing service may determine a corresponding row operation to be performed on the table to which the transaction is matched. For example, the parsing service may evaluate the transaction type value the transaction comprises to determine a corresponding row operation such as the insertion of a new row, the updating of an existing row, or the removal of a row.

Accordingly, data in the table may be created, and updated by successively applying the series of row operations determined from the transactions (506). In order to apply the row operations in the correct order, in certain embodiments, the parsing service 128 keeps track of the order in which the transactions in the raw data 130 are stored. The parsing service 128 then applies the row operations determined from each transaction in the same order in which the transactions are stored (506). In certain embodiments, the parsing service 128 may retrieve the transactionID value that each transaction comprises in order to determine the order in which the transactions that are matched to a particular table should be applied.

In certain embodiments, a database storing parsed data 132 for a study may store metadata that includes values for identifying the first and last transactions (e.g. in terms of the order in which they are stored in the raw data 130, or the order of their transaction IDs) of the most recent update. For example, a “Start Transaction ID” field may be used to store a value of a transaction identifier (ID) that identifies the first transaction used in the most recent update. Similarly, an “End Transaction ID” field may be used to store a value of a transaction identifier (ID) that identifies the last transaction used in the most recent update.

Parsed data 132 therefore represents more desirable, intermediate, data format to be accessed by client applications than raw data 130. In particular, generating and storing parsed data effectively pre-computes many of the operations required to sort, combine, and manipulate portions of raw data 130 and caches the result in an up to date intermediate database. Typically, stakeholders attempting to access clinical trial data from an EDC source would otherwise be required to carry out these operations themselves. Accordingly, providing parsed data 132 significantly reduces the time and effort required for a stakeholder to obtain the data they require to perform their roles in, or in association with a clinical trial sponsor organization.

In certain embodiments parsing the source data (e.g. EDC ODM-XML data) is performed in order to facilitate the storage of the raw data in a particular type of data base. For example, raw data may be stored using a document database, wherein each extracted snapshot or transaction is stored as a document in the document database.

In certain embodiments, in order to maintain data fidelity and consistency, before incorporating the data from the extracted snapshots or applying the extracted transactions in order to update the parsed data, the parsing service 128 may first check metadata stored in a metadata table in the parsed data for a particular study. For example, similar to the process of FIG. 4, the parsing service 128 may check the value of a “Read Lock” field stored in the metadata table to determine if a study database is currently being read from. If the value of the “Read Lock” field indicates that the database is not currently being read from (e.g. if the value of the “Read Lock” field is “N”), the process may proceed to set the value of a “Write Lock” field stored in the metadata table in order to indicate that the database is locked for writing. For example, the parsing service 128 may set the value of the “Write Lock” field to “Y”. Similarly, in certain embodiments, once all the row operations have been completed for each table, the success of the write operation may be checked. If the write is confirmed to have been successful, the “Write Lock” field may be set to “N”, to allow further reading from the parsed data 132.

In certain embodiments, when parsed data is generated from transactional ODM-XML data, two copies of the parsed data 132 for a particular study may be stored in two different databases. In certain embodiments, each database may also include a “Version #” metadata field that records the number of times each database has been updated. In certain embodiments, a first database stores the previous version of the parsed data 132, and a second database stores the most recent version of the parsed data 132. Accordingly, the value of the “Version #” field may be used to distinguish between the first database storing the previous version of the parsed data and the second database storing the most recent version of the parsed data 132.

Each time the parsing service 128 is triggered to update the parsed data 132 for a given study, the parsing service compares the values of the “Version #” fields in the two database copies to identify the first database storing the previous version of the parsed data and the second database storing the most recent version of the parsed data. Before applying the new set of raw data corresponding to new updates from the data writer Service 126, the parsing Service 128 may first retrieve the raw data 130 corresponding to the previous set of updates. The set of raw data 130 corresponding to the previous set of updates may be identified and retrieved by reading the value of the “Start Transaction ID” and the value of the “End Transaction ID” from the second database that stores the current version of the parsed data 132.

The parsing service 128 may then use the retrieved previous set of raw data to update the first database in accordance with the method shown in FIG. 5, so that it is updated to store the same version of the parsed data 132 as the second database. Following the update, the value in the “Version #” field of the first database is incremented by one. The parsing service 128 may then update the first database a second time, using the new set of raw data received from the data writer service 126, and increment the value stored in the “Version #” field of the first database.

In certain embodiments, the monitoring service 116 may be used to check for failures in the updating of parsed data. For example, the monitoring service 116 may check the values stored in the “Version #”, “Write Lock” and “Read Lock” fields of each of the two copies of the databases used to store parsed data 132 for a particular study. If updating the parsed data has failed, the value of the “Write Lock” for one of the databases will be set to “Y”. The monitoring service 116 may identify this database as a corrupted database. The “End Transaction ID” in this corrupted database will be used to start the failover process and will be passed on to the parsing service 128. The parsing service 128 will then determine if this database needs to be updated or not (in case the update is already in progress).

If the parsing service 128 determines that the database is not currently being updated, it will update the database according to the following method. The parsing service 128 will retrieve the raw data for the given study beginning with the transaction that is indexed by the value stored in the “End Transaction ID” plus one (e.g. the transaction after the transaction associated with the value stored in the “End Transaction ID” field) until the last transaction. The parsing service 128 may then update the corrupted database using the retrieved raw data, in accordance with the method of FIG. 5. Once the update has been completed, the parsing service 128 may set the value of the “Version #” field in the corrupted database to one greater than the value in the “Version #” field of the uncorrupted database. Finally, the parsing service 128 may change the “Write Lock” to “N” in order to make this newest version of database available for reads.

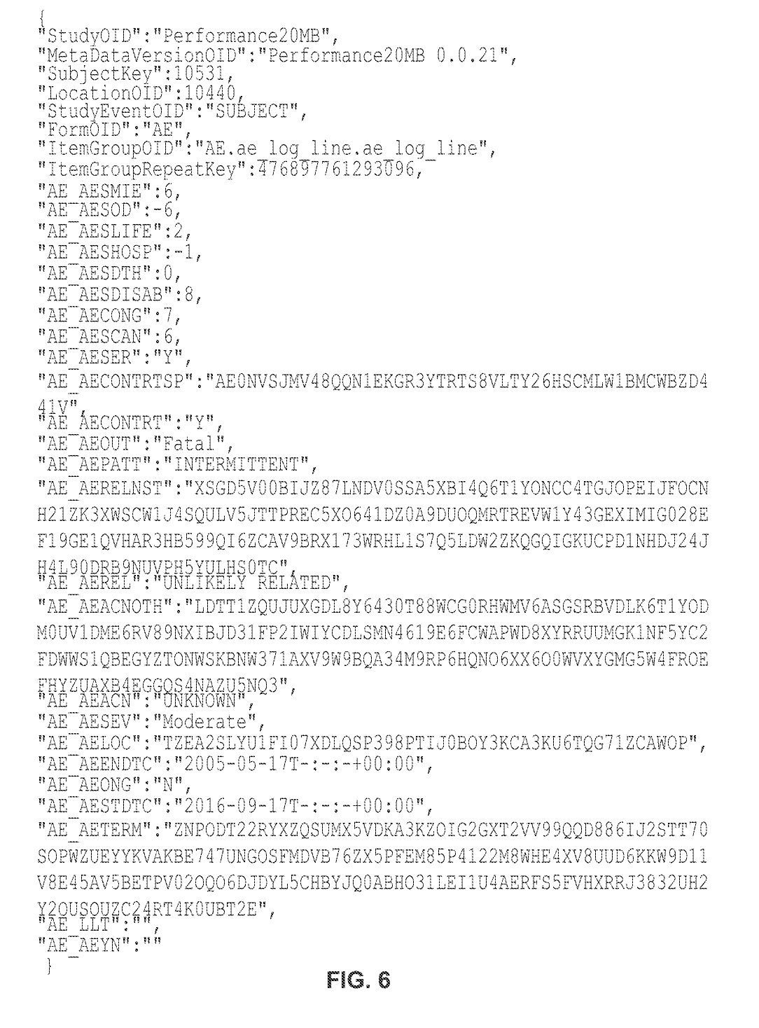

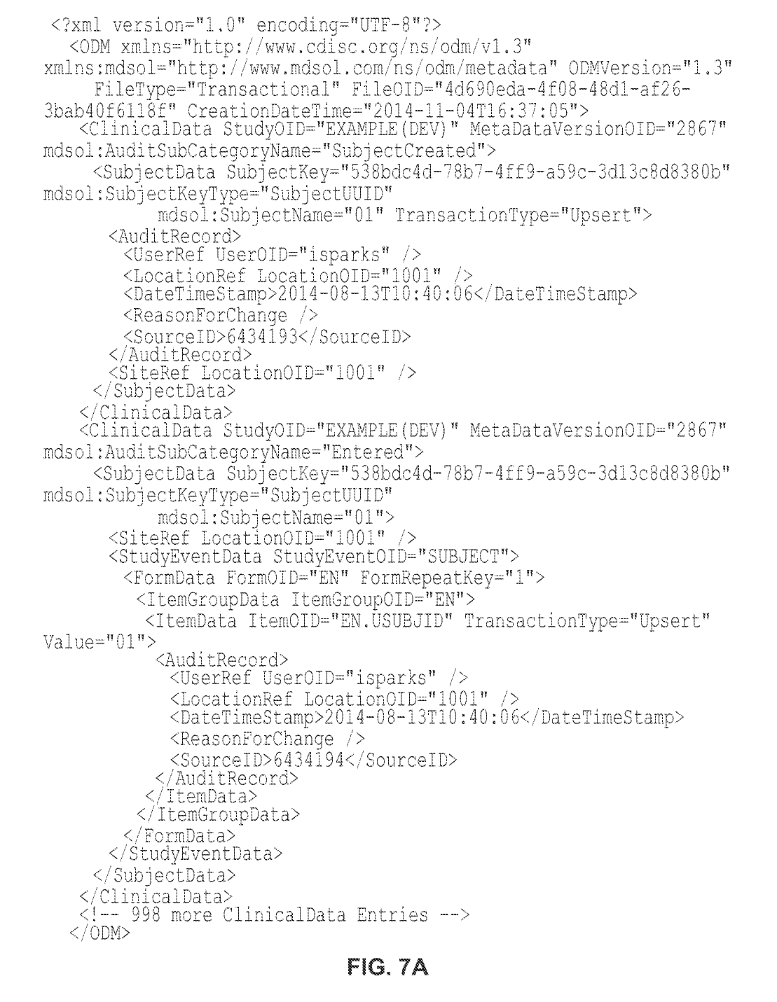

In a particular embodiment wherein parsed data is stored in a database using MongoDB, data from different clinical trials may be stored in separate databases. In a given study, each table corresponds to a collection, and each row in the table may be stored separately as a JSON document. Each field in the JSON document represents column heading, and each corresponding value gives the particular value of the cell corresponding to the row, column pair. An example of a JSON document for storing a row in an Adverse Events collection is shown in FIG. 6. An Adverse Events collection would comprise a series of JSON documents such as the one in FIG. 6 each storing data corresponding to a different row in the table. Similarly, for example, demographics information would be stored in a separate demographics collection, with a series of analogous JSON documents storing relevant data.

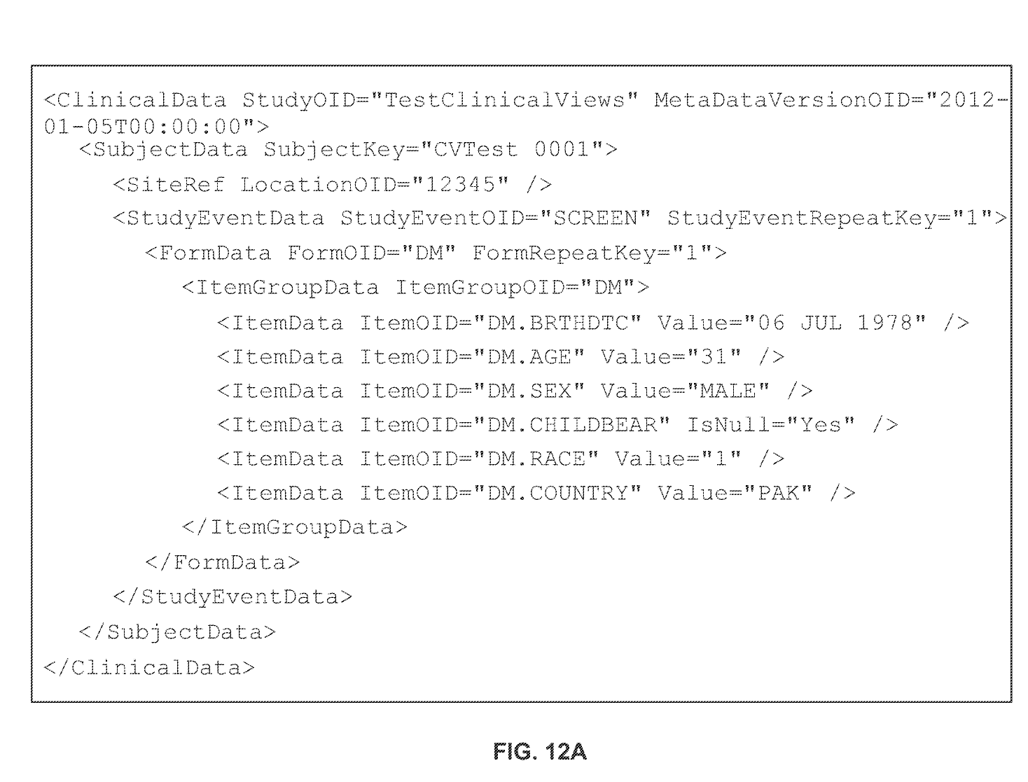

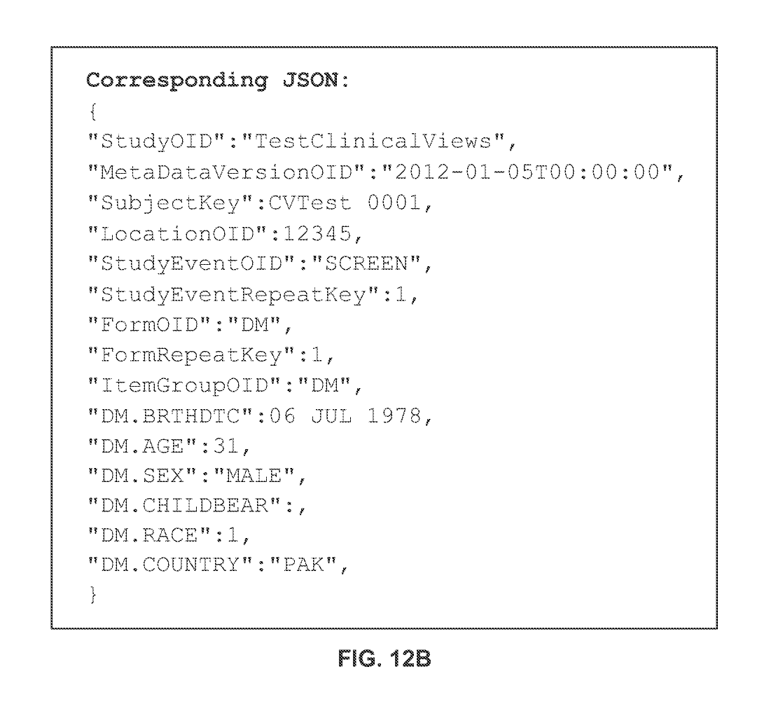

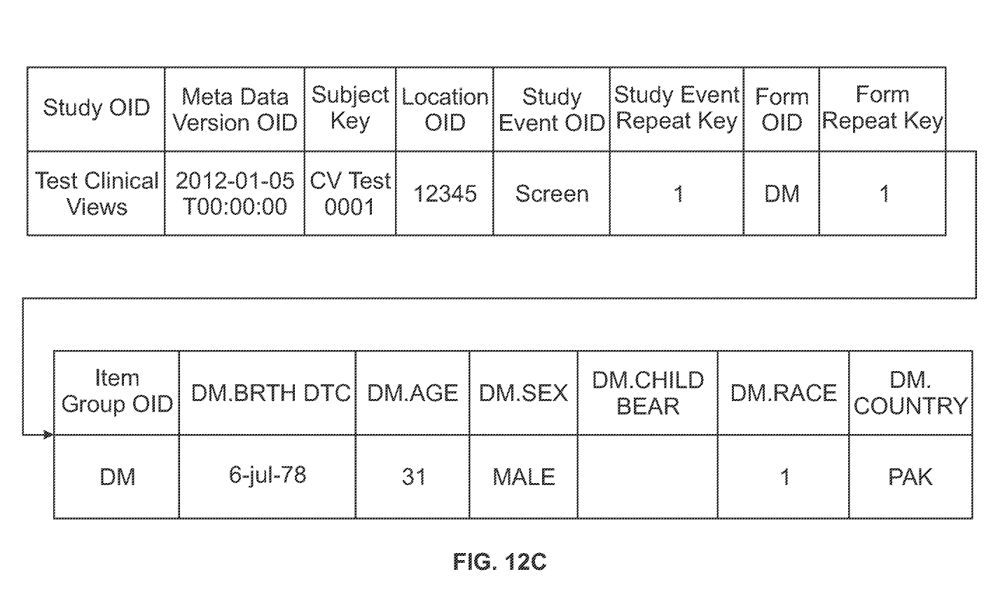

FIG. 12A shows an example of ODM-XML data represented as snapshot data in an XML document. FIG. 12B shows a corresponding JSON document that is used to store the corresponding row in a table in the parsed data. In certain embodiments, although a document database may be used to store the parsed data, when data is served to client applications it may still be represented visually as a table with horizontal rows and vertical columns. For example, the JSON document shown in FIG. 12B may be represented visually as a row in a table as shown in FIG. 12C.

In particular embodiments based on MongoDB, for each collection, a unique collection name may be generated. For example, collection names may take the format EDCSourceName/ServerName:StudyName:TableName.

Data for particular collections, or subsets thereof can be accessed and retrieved using database specific commands. For example, the command “CollectionName.find( )” provides all the data for a particular clinical or operational data table. In the case of MongoDB, additional parameters may be passed to the CollectionName.find( )method to further filter data retrieved from the master data storage module 136. In an implementation such as MongoDB, the individual fields of the JSON documents such as StudyEventOID, SubjectKey, may be indexed for efficient filtering while retrieving the data. Indexing may also reduce the amount of data retrieved for large studies thereby improving performance.

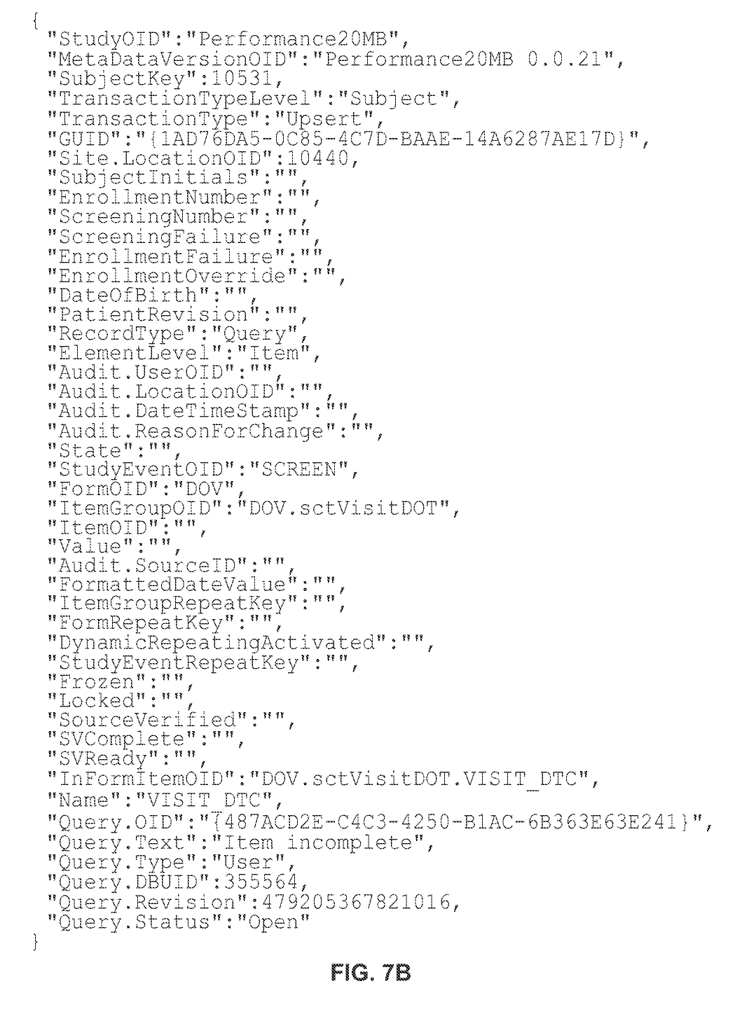

In certain embodiments, parsed data includes operational data as well as clinical data. In certain embodiments, operational data is stored as a single collection in a MongoDB database. An example of a portion of operational data retrieved from an EDC source as an XML document is shown in FIG. 7A. The operational data XML document follows a similar structure to the XML documents storing clinical data (e.g. in FIG. 2A, FIG. 2B, FIG. 3A, and FIG. 3B). Accordingly, EDC ODM-XML data comprising operational data can be parsed in order to extract a series of snapshots or transactions comprising operational data. Operational data comprises elements such as audit records, queries, comments, and signatures that may be represented as columns in a data table of operational data. Accordingly, an example JSON document corresponding to a single row in an operation data table is shown in FIG. 7B.

In other embodiments, separate data tables (e.g. separate collections in a MongoDB implementation) may be used to store different types of operational data, such as, e.g. audit records, queries, comments and signatures. For example, for operational data, indexing may also be employed to retrieve data based on the values of one or more of the following fields or their combinations: query, comments, audit records, signatures.

The process in FIG. 5 may be used to generate parsed data in accordance with the embodiment using MongoDB. In the MongoDB implementation of the present embodiment, the Parsing Service may check the “Read Lock” value by accessing a “Header Document” stored in a metadata collection in the database. In the MongoDB implementation, a new JSON document is created for each new row (for an insert operation) in the raw data, and stored in the collection corresponding to the respective form template. For raw data of the transaction type, when update transactions are identified, the corresponding JSON document is located and updated accordingly. Once all transactions have been applied, the Parsing Service 128 confirms the fidelity of the write, and if a write was successful, sets the “Write Lock” flag to “N”.

In certain embodiments, wherein the parsed data is stored using a document database such as MongoDB each row corresponds to a document such as a JSON document in the database of parsed data. Accordingly, the insertion of a new row corresponds to the creation of a new document in the database of parsed data. Similarly, the replacement or updating of a row in a data table in the parsed data corresponds to the replacement or updating of a document in the database of parsed data.

In certain embodiments, the raw data may also be stored as a document database. Accordingly, prior to storing the EDC ODM-XML data as raw data in the master data storage module, a parsing step such as step 502 in 500 may be performed to extract snapshots or transactions from the EDC data.

In certain embodiments, each extracted block of snapshot data is stored as a JSON document in the raw data 130 of the master data storage module. Since each extracted block of snapshot data stores a form entry, the JSON document storing the extracted block of snapshot data after the parsing step is the same as the JSON document that stores the corresponding row in the database of parsed data. Accordingly, creating parsed data from the snapshot data may simply comprise overwriting the existing JSON documents in the parsed data with the new JSON documents that store the extracted blocks of snapshot data.

In certain embodiments, after extracting transactions from transactional data, each extracted transaction may also be stored as a JSON document in the raw data of the master data storage. In order to create parsed data from the extracted transactions, however, the parsing service still may need to match the extracted transactions to the data tables in the parsed data and apply the extracted transactions in the correct order to update the clinical trial data.

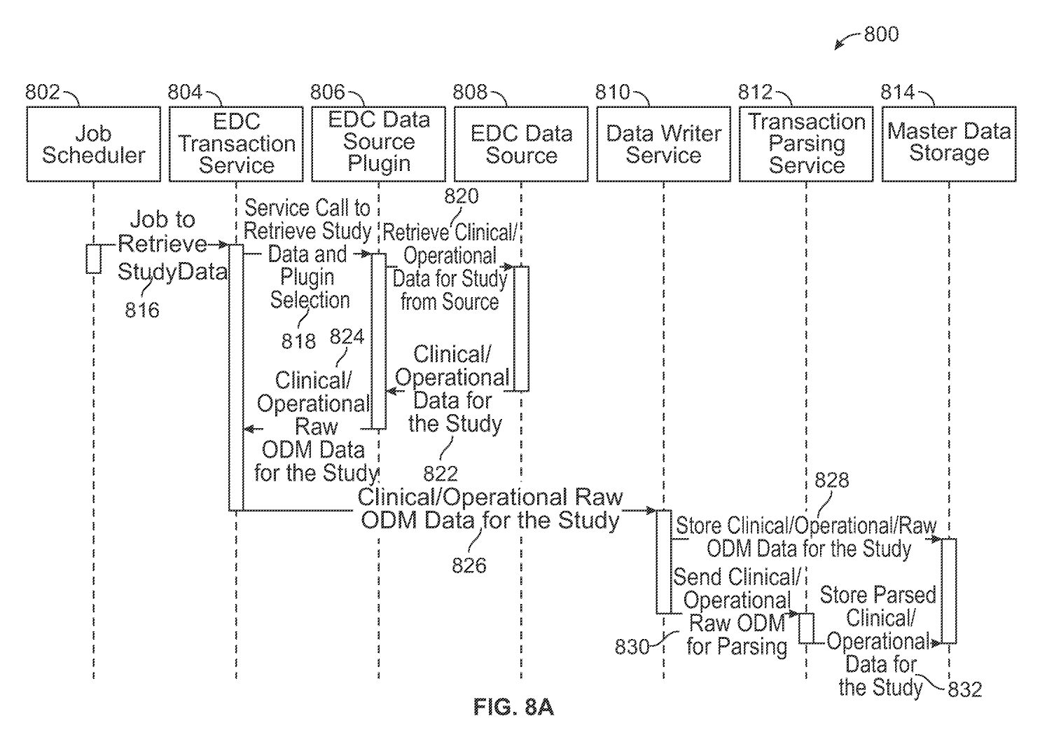

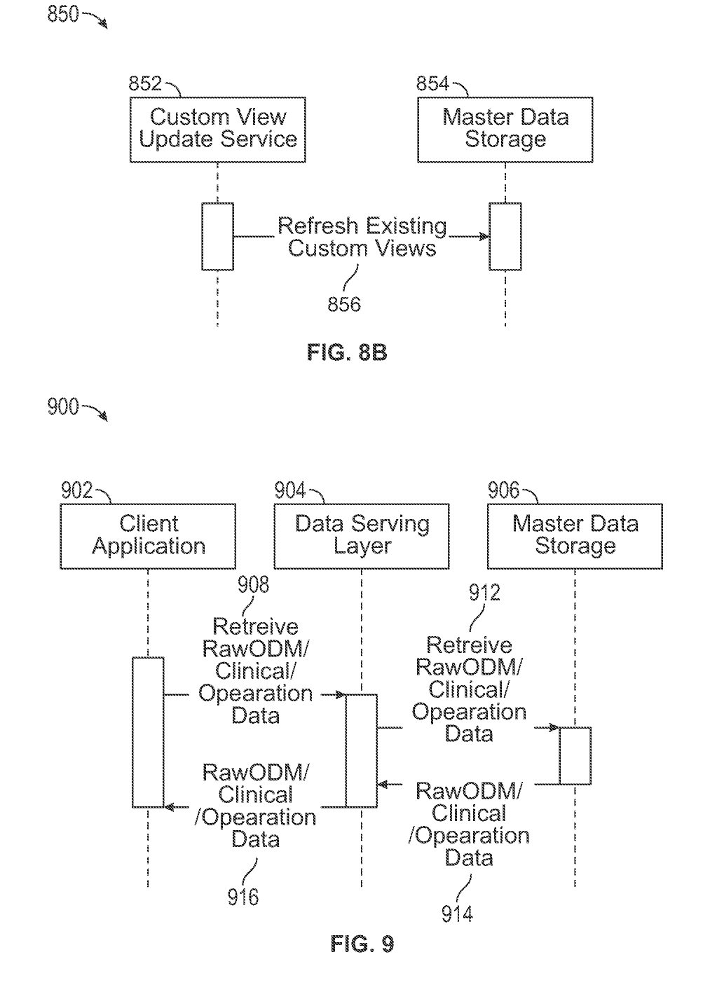

FIG. 8A is a schematic illustrating interactions between the different subsystems and components of the data caching architecture that is used to create and update the parsed data, according to an illustrative embodiment. As described herein, the job scheduler 802 of the data ingestion layer 104 manages the creation and execution of data collection jobs that retrieve data from an EDC data source 808 and passes it to the data writer service 810 and parsing service 812 of the data storage layer 106 in order to create and/or update raw data and parsed data.

In certain embodiments, the job scheduler 802 initiates the process by causing the execution of a data collection job to retrieve study data. The data collection job is sent to the EDC transaction service at step 816. According to the data collection job, the EDC transaction service 804 selects an EDC data source plugin 806 to use to retrieve the study data from an EDC source, and issues a call to the selected EDC data source plugin (818).

The EDC data source plugin 806 communicates with the EDC data source 808 in order to retrieve clinical and/or operational data for a study from the EDC data source (820). The EDC data source 808 provides the EDC data source plugin 806 with clinical and/or operational data for the study, corresponding to raw data (822). The EDC data source plugin provides the raw data to the EDC transaction service 804 (824). The EDC transaction service 804 then provides the raw data to the data writer service 810 of the data management layer 106 (826). The data writer service 810 stores the raw data in the master data storage module 814 (828). The data writer service 810 additionally provides the raw data to the parsing service 812 (830) and triggers the parsing service 812 to begin creating or updating parsed data, and storing the created or updated parsed data in the master data storage module 814 (832).

In certain embodiments, the master data storage module 136 may also store custom data views 134. Custom data views are specific formats that have been predefined based on a particular set of stakeholder needs. For example, a custom data view is created from a particular subset of clinical data for a single clinical trial study that is relevant for a particular stakeholder. For example, a stakeholder responsible for pharmacovigilance may require only data representing subjects having adverse events, and, accordingly, define a custom data view that stores and updates adverse event data for a particular study. In certain embodiments, a custom data view may be created from data from multiple clinical trial studies. For example, a stakeholder responsible for pharmacovigilance across multiple clinical trial studies may define a custom data view that stores and updates adverse event data from a combination of clinical trial studies. Each custom data view may be updated regularly, to reflect the current state of the clinical trial data, as with the parsed data and raw data. As shown in the illustrative embodiment of FIG. 8B, the updating of the custom data views is handled by the custom view update service 852.

Custom data views thereby provide a cached version of clinical trial data that closely matches specific data that a particular stakeholder (or set of stakeholders) will be interested in. The cached custom data views therefore anticipate stakeholder needs to an even greater degree than the parsed data. Providing custom data views pre-computes a large fraction of the data processing operations that would typically need to be carried out by the stakeholders themselves in order for them to access and utilize clinical trial data. Accordingly, the processing required each time a stakeholder accesses data in a custom data view is significantly reduced from the processing that would otherwise be necessary to retrieve, organize and process the same data directly from an EDC source.

In a particular implementation using MongoDB, each custom data view may be stored as a single collection. Accordingly, instead of performing the processing required to create a custom data view from different portions of clinical trial data from one or more studies, a stakeholder merely needs to access and retrieve an existing collection in a database of custom data views.

In certain embodiments, the custom data views may also include operational data as well as clinical data. In certain embodiments, operational data is stored as a single collection in a MongoDB database storing the custom data views. In other embodiments, separate data tables (e.g. separate collections in a MongoDB implementation) may be used to store different types of operational data, such as, e.g. audit records, queries, comments and signatures. As with parsed data, in the custom data views indexing may also be employed to retrieve data based on the values of one or more of the following fields or their combinations: query, comments, audit records, signatures.

### Data Serving Layer

The data serving layer 108 responds to client application requests by providing both clinical and operational data to client applications 110. Examples of client applications include TIBCO Spotfire, Tableau, Microsoft Excel, Qlikview for building dashboard visualizations and performing analysis

The data serving layer 108 comprises three subsystems for interfacing with client applications, in order to manage requests for three different types of data. These correspond to the clinical data view service 142, operational data view service 144, and raw ODM Data view service 146. These three services interface with the data reader service in order to direct client requests for data to the appropriate database in the master data storage module, retrieve the data, and serve it to a client application.

In certain embodiments, the clinical data view service 142, upon receiving a request for data from a client application first determines whether the request may be served by reading data from the parsed data for a particular study, or may be served by reading data from a custom view, or through the raw dataset providing raw that has been converted back from JSON to ODM-XML format. The clinical data view service 142 then directs the data reader service 140 to retrieve data from the appropriate parsed data set or custom view, and, upon receiving data from the data reader service 140, provides it to the client application 110. In certain embodiments, the clinical data view service 142 may merge multiple clinical data tables into a custom data table.

In certain embodiments, the operational data view service 144 then directs the data reader service 140 to retrieve data from the appropriate parsed data set or custom view, and, upon receiving data from the data reader service 140, provides it to the client application 110. In certain embodiments, the raw data view service 146 reads raw data obtained from the data reader service 140, which then reads the raw data from the master data storage module (by converting it back from JSON to ODM-XML) and serve it to the client applications for critical scenarios.

The data serving layer 108 uses the data reader service 140 to handle the process of retrieving data from the master data storage module 136 and providing it to the view services. For example, the data reader service 140 manages different read operations by maintaining a global list of read requests (e.g. corresponding to a list of multiple requests for data from multiple client applications), from different clients belonging to both the services, by translating them into appropriate read operations. Additionally, the data reader service 140 handles setting and checking the “Read Lock” and “Write Lock” values of the particular databases.

An example process for reading parsed data performed by the data reader service 140 is described as follows. As described herein, in certain embodiments two copies of the parsed data for a particular study may be stored in separate databases in the master data storage module 136. When reading parsed data for a particular study, the data reader Service 140 may first check the “Write Lock” value, and the “Version #” value of both copies of the databases storing the parsed data for a given study. If both the databases have different “Write Lock” values, the data reader service 140 may read from the database whose corresponding “Write Lock” value indicates that it is not being written to (e.g. value of “N”). If both the databases have a “Write Lock” value that indicates neither database is being written to (e.g. both having a “Write Lock” value of “N”), then the data reader service 140 may read data from the database with the higher version number.

Before starting the read operation, the data reader service 140 may change the “Read Lock” flag value to “Y” in order to avoid any writes by the parsing service 128 during a read process. Once the read operation is completed, the “Read Lock” is removed by rolling back its value to “N”. If there is any read request pending in the global list, the “Read Lock” flag will remain “Y” until all the read requests have been handled and results are served to the client application.

FIG. 9 is a flow diagram illustrating the interaction between a client application 902, the data serving layer 904 and the master data storage module 906 in an example method 900 for interfacing with client applications 902 in order to provide them with data from the master data storage module 906. A particular client application 902 issues a request to retrieve data to the data serving layer 904. The request (908) may be a request for clinical data, operational data or raw data.

As described herein, the request for data is handled by the appropriate view service depending on the type of data that is requested. The appropriate view service of the data serving layer 904 retrieves the data (912) from the master data storage module 906 via the data reader service 140. The data serving layer 904 thereby reads the raw data or clinical data or operational data from the master data storage module 906 and provides it to the client application 902.

### Security Service

In certain embodiments, the security service 112 contains individual components for handling security mechanisms in different EDC systems 148. For example, components of the security service 112 may contain authorize user access to certain studies in accordance with the protocols of the particular associated EDC system.

### Admin Service

In certain embodiments, the admin service 114 comprises methods and systems for communicating with different EDC systems to, for example, retrieve a list of available studies for a given URL, or retrieve study metadata.

### Network and Computing Implementation

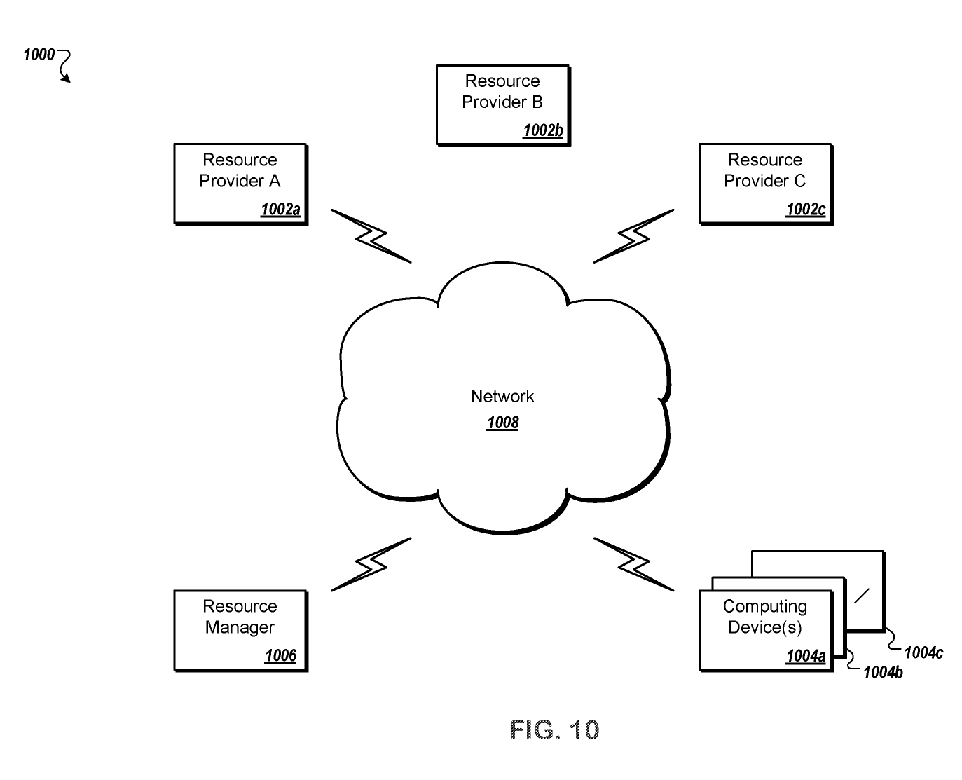

As shown in FIG. 10, an implementation of a network environment 1000 for use providing systems and methods for processing and storing data recorded in clinical trials as described herein is shown and described. In brief overview, referring now to FIG. 10, a block diagram of an exemplary cloud computing environment 1000 is shown and described. The cloud computing environment 1000 may include one or more resource providers 1002a, 1002b, 1002c (collectively, 1002). Each resource provider 1002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1002 may be connected to any other resource provider 1002 in the cloud computing environment 1000. In some implementations, the resource providers 1002 may be connected over a computer network 1008. Each resource provider 1002 may be connected to one or more computing device 1004a, 1004b, 1004c (collectively, 1004), over the computer network 1008.

The cloud computing environment 1000 may include a resource manager 1006. The resource manager 1006 may be connected to the resource providers 1002 and the computing devices 1004 over the computer network 1008. In some implementations, the resource manager 1006 may facilitate the provision of computing resources by one or more resource providers 1002 to one or more computing devices 1004. The resource manager 1006 may receive a request for a computing resource from a particular computing device 1004. The resource manager 1006 may identify one or more resource providers 1002 capable of providing the computing resource requested by the computing device 1004. The resource manager 1006 may select a resource provider 1002 to provide the computing resource. The resource manager 1006 may facilitate a connection between the resource provider 1002 and a particular computing device 1004. In some implementations, the resource manager 1006 may establish a connection between a particular resource provider 1002 and a particular computing device 1004. In some implementations, the resource manager 1006 may redirect a particular computing device 1004 to a particular resource provider 1002 with the requested computing resource.

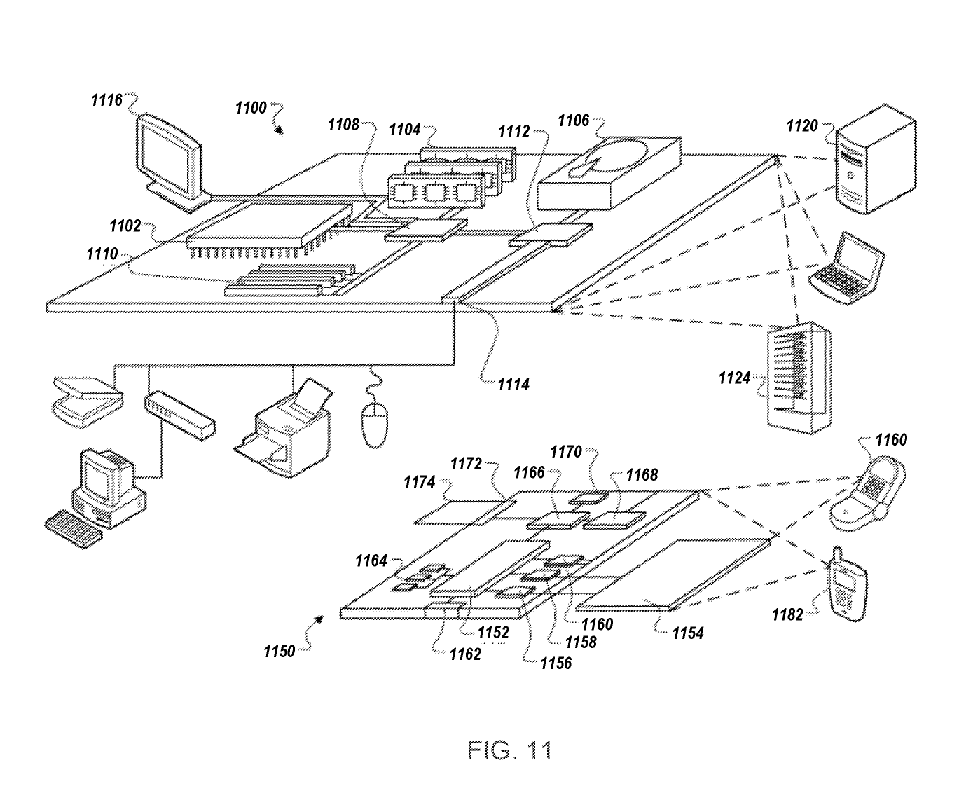

FIG. 11 shows an example of a computing device 1100 and a mobile computing device 1150 that can be used to implement the techniques described in this disclosure. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108 connecting to the memory 1104 and multiple high-speed expansion ports 1110, and a low-speed interface 1112 connecting to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as a display 1116 coupled to the high-speed interface 1108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1104 stores information within the computing device 1100. In some implementations, the memory 1104 is a volatile memory unit or units. In some implementations, the memory 1104 is a non-volatile memory unit or units. The memory 1104 may also be another form of computer-readable medium, such as a magnetic or optical disk.

The storage device 1106 is capable of providing mass storage for the computing device 1100. In some implementations, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1102), perform one or more methods, such as those described above. The instructions can also be stored by one or more storage devices such as computer- or machine-readable mediums (for example, the memory 1104, the storage device 1106, or memory on the processor 1102).

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards (not shown). In the implementation, the low-speed interface 1112 is coupled to the storage device 1106 and the low-speed expansion port 1114. The low-speed expansion port 1114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device (not shown), such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152, a memory 1164, an input/output device such as a display 1154, a communication interface 1166, and a transceiver 1168, among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate.

The processor 1152 can execute instructions within the mobile computing device 1150, including instructions stored in the memory 1164. The processor 1152 may be implemented as a chipset of chips that include separate and multiple analog and digital processors. The processor 1152 may provide, for example, for coordination of the other components of the mobile computing device 1150, such as control of user interfaces, applications run by the mobile computing device 1150, and wireless communication by the mobile computing device 1150.

The processor 1152 may communicate with a user through a control interface 1158 and a display interface 1156 coupled to the display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a SIMM (Single In Line Memory Module) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provide as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1152), perform one or more methods, such as those described above. The instructions can also be stored by one or more storage devices, such as one or more computer- or machine-readable mediums (for example, the memory 1164, the expansion memory 1174, or memory on the processor 1152). In some implementations, the instructions can be received in a propagated signal, for example, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1168 using a radio-frequency. In addition, short-range communication may occur, such as using a Bluetooth®, Wi-Fi™, or other such transceiver (not shown). In addition, a GPS (Global Positioning System) receiver module 1170 may provide additional navigation- and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in the figure. For example, it may be implemented as a cellular telephone 1180. It may also be implemented as part of a smart-phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for processing and storing data recorded in clinical trials are provided. Having described certain implementations of methods and apparatus for supporting an a system and method for the processing and storage of data recorded in clinical trials it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

1. A method for managing clinical trial data from one or more studies, the method comprising the steps of:
(a) retrieving, by a processor of a computing device, source data comprising clinical trial data;
(b) parsing the retrieved source data to extract data in at least one format selected from the group consisting of (i) and (ii) as follows:
(i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and
(ii) one or more transactions, wherein each of the one or more transactions comprises instructions for performing an incremental modification to at least a portion of the clinical trial data; and
(c) storing the extracted data in a database of raw data for retrieval by a client application and/or further processing.

2. (canceled)

3. The method of claim 1, comprising retrieving, by the processor of the computing device, the source data at one or more times according to a pre-defined process.

4. The method of claim 3, wherein the pre-defined process comprises at least one of (i) and (ii) as follows:
(i) performing one or more steps at a regular interval of time; and
(ii) performing one or more steps at a pre-defined list of times.

5.-9. (canceled)

10. The method of claim 1, wherein the source data is retrieved from one of one or more sources of clinical trial data, and retrieving the source data from the source of clinical trial data comprises:
calling a data source plugin, wherein the data source plugin comprises a set of instructions for requesting data from the source of clinical trial data;
issuing, via the data source plugin, a request for data to the source of clinical trial data; and
receiving, via the data source plugin, raw data from the source of clinical trial data.

11. The method of claim 1, wherein the source data is EDC Operational Data Model data (EDC ODM data) corresponding to an XML file conformant to the Clinical Interchange Standards Consortium (CDISC) specification.

12. (canceled)

13. The method of claim 1, wherein the extracted data comprises one or more blocks of snapshot data.

14.-18. (canceled)

19. The method of claim 13, comprising providing for display and/or processing by the client application, responsive to a request for data from the client application, at least a portion of the extracted blocks of snapshot data stored in the database of raw data.

20. The method of claim 1, wherein the extracted data comprises one or more transactions.

21.-25. (canceled)

26. The method of claim 20, comprising providing for display and/or processing by the client application, responsive to a request for data from the client application, at least a portion of the extracted transactions stored in the database of raw data.

27. The method of claim 13, comprising updating a database of parsed data, wherein updating the database of parsed data comprises:
for each extracted block of snapshot data:
identifying a form to which the extracted block of snapshot data belongs;
matching the extracted block of snapshot data to a table in the database of parsed data, wherein the table to which the block of snapshot data is matched contains one or more form entries belonging to the same form to which the extracted block of snapshot data belongs; and
updating the table to which the block of snapshot data is matched to incorporate a form entry, wherein the extracted block of snapshot data comprises the form entry.

28. The method of claim 27, wherein updating the table comprises at least one of (i) inserting a new row in the table and (ii) replacing an existing row in the table, based on whether or not the extracted block of snapshot data corresponds to an existing row in the table.

29. The method of claim 20, comprising updating a database of parsed data based on the instructions for performing an incremental modification to at least a portion of the clinical trial data that each of the one or more transactions comprises.

30. The method of claim 29, wherein updating the database of parsed data comprises:
for each extracted transaction:
identifying a form to which the extracted transaction belongs;
matching the extracted transaction to a table in the database of parsed data, wherein the table to which the extracted transaction is matched contains one or more form entries belonging to the same form to which the extracted transaction belongs; and
applying the extracted transaction to update the table to which the transaction is matched in accordance with the instructions corresponding to the extracted transaction.

31. The method of claim 30, wherein applying the extracted transaction comprises:
determining a transaction type of the extracted transaction and, based on the determined transaction type, performing at least one of (i), (ii), and (iii) as follows:
(i) inserting a new row into the data table to incorporate a form entry stored in the extracted transaction;
(ii) updating an existing row in the data table to incorporate one or more data values stored in the extracted transaction; and
(iii) removing an existing row in the data table.

32. The method of claim 31 comprising:
matching a first transaction to a first data table in the database;
matching a second transaction to the first data table;
determining an order in which to apply the first transaction and the second transaction; and
applying the first transaction and the second transaction in the determined order.

33.-34. (canceled)

35. The method of claim 27, comprising providing, responsive to a request for data from the client application, at least a portion of one or more of the tables in the database of parsed data.

36. The method of claim 27, comprising, responsive to the retrieval of the source data, triggering updating the database of parsed data.

37. (canceled)

38. The method of claim 27, comprising updating, by the processor, a custom data view, wherein the custom data view comprises one or more custom data tables and updating a custom data view comprises:
accessing a pre-defined template that comprises one or more criteria;
accessing the database of parsed data in order to retrieve one or more form entries from the database of parsed data, wherein each retrieved form entry satisfies at least one of the one or more criteria;
updating one or more custom data tables to incorporate at least a portion of one or more retrieved form entries; and
storing the one or more custom data tables in a database of custom data views.

39. The method of claim 38, wherein the database of custom data views is part of a master data storage module that stores clinical trial data for one or more studies.

40. The method of claim 38, wherein each of the one or more criteria comprises at least one of (i) a clinical trial to which a form entry must belong, (ii) a subject to which a form entry must belong, (iii) a study event to which a form entry must belong, and (iv) a form to which a form entry must belong.

41. The method of claim 38, wherein a first form entry incorporated into a custom data table belongs to a first clinical trial and a second form entry incorporated into a custom data table belongs to a second clinical trial, wherein the second clinical trial is a different clinical trial from the first clinical trial.

42. The method of claim 38, comprising periodically updating the custom data view to reflect updates to the clinical trial data.

43. The method of claim 38, comprising, providing, responsive to a request from the client application, at least a portion of one of the custom data tables.

44. (canceled)

45. A system for managing clinical trial data from one or more studies, the system comprising:
a processor; and
a memory having instructions stored thereon, wherein the instructions, when executed by the processor, cause the processor to:
(a) retrieve source data comprising clinical trial data;
(b) parse the retrieved source data to extract data in at least one format selected from the group consisting of (i) and (ii) as follows:
(i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and
(ii) one or more transactions, wherein each of the one or more transactions comprises instructions for performing an incremental modification to at least a portion of the clinical trial data; and
(c) store the extracted data in a database of raw data for retrieval by a client application and/or further processing.

46-88. (canceled)

89. A data caching system comprising:
a data ingestion layer for retrieving source data from a clinical trial data source.
a data management layer for:
(a) parsing the retrieved source data to extract data in at least one format selected from the group consisting of (i) and (ii) as follows:
(i) one or more blocks of snapshot data, wherein each extracted block of snapshot data comprises a form entry, each form entry comprising a set of clinical trial data recorded for a particular subject, at a particular study event, and using a particular form comprising a list of predefined fields for which data is collected; and
(ii) one or more transactions, wherein each of the one or more transactions comprises instructions for performing an incremental modification to at least a portion of the clinical trial data; and
(b) storing the extracted data in a database of raw data for retrieval by a client application and/or further processing; and
a data serving layer for retrieving at least a portion of the data from the one or more databases of raw data, and providing the data to the client application.

90-112. (canceled)
